(19) United States
(12) Patent Application Publication
(10) Pub. No.: US 2010/0254453 A1
(43) Pub. Date: Oct. 7, 2010

(54) INVERSE TELECINE TECHNIQUES

(75) Inventors: Gokce Dane, San Diego, CA (US); Chia-yuan Teng, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/417,527

(22) Filed: Apr. 2, 2009

(51) Int. Cl. H04N 7/32; H04N 7/01

(52) U.S. Cl. 375/240.12; 348/459; 375/E07.243; 348/E07.003

(57) ABSTRACT

This disclosure describes inverse telecine techniques that are performed to adjust or convert the frame rate of a video sequence. The described techniques provide a very useful way to identify a telecine technique that was used to increase the frame rate of a video sequence. Upon identifying the telecine technique that was used, the corresponding inverse telecine technique can be performed with respect to the sequence of video frames in order to decrease the frame rate back to its original form (prior to telecine). This disclosure also provides many useful details that can improve inverse telecine, e.g., by simplifying the inverse telecine process and by reducing memory accesses during the process.

### TECHNICAL FIELD

This disclosure relates to digital video encoding and decoding and, more particularly, telecine and inverse telecine techniques, in which the frame rate of a video sequence is changed.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, video gaming devices, video game consoles, cellular or satellite radio telephones, and the like. Digital video devices implement video compression techniques, such as those described in standards defined by MPEG-2, MPEG-4, or ITU-T H.264/MPEG-4, Part 10, Advanced Video Coding (AVC), to transmit and receive digital video information more efficiently. Video compression techniques may perform block-based spatial prediction and/or temporal prediction to reduce or remove redundancy inherent in video sequences.

Telecine techniques may be used to change the frame rate of a video sequence. Telecine techniques are desirable, for example, to enable a motion picture that was originally captured on film media to be viewed with standard video equipment, such as televisions, video media players or computers. In particular, telecine techniques may be used to change a conventional video sequence from 24 frames per second (which is common with motion picture films recorded on film media) to 30 frames per second (which is common for digital video played by digital equipment).

Inverse telecine techniques perform the inverse operations of telecine techniques. Thus, if telecine techniques convert a video sequence from 24 frames per second to 30 frames per second, the inverse telecine techniques may convert the video sequence from 30 frames per second back to 24 frames per second. In some cases, telecine techniques may be performed as part of a video encoding process, while inverse telecine techniques may be performed as part of a video decoding process.

In some cases, inverse telecine can be part of a transcoding process. In this case, inverse telecine may be implemented as part of a transcoder, or as part of an encoder or a decoder. In the case of transcoding, the telecined content may be converted back to an original frame rate, such as 24 frames per second, and re-encoded according to a different encoding format. Inverse telecine, in this case, may occur prior to the transcoding process, and may be implemented in a transmitting device that sends data to the transcoder, or a receiving device that performs the transcoding.

Telecine and inverse telecine, however, are not limited to video encoding or decoding scenarios. Telecine and inverse telecine techniques may be used for many reasons independent of any spatial- or temporal-based video encoding or decoding. Basically, anytime it is desirable to change the frame rate of a video sequence, telecine may provide a useful way to achieve this goal.

### SUMMARY

In general, this disclosure describes inverse telecine techniques that are performed to adjust or convert the frame rate of a video sequence. The described techniques provide a useful way to identify a telecine technique that was used to increase the frame rate of a video sequence. Upon identifying the telecine technique that was used, the corresponding inverse telecine technique can be performed with respect to the sequence of video frames in order to reduce the frame rate back to its original form (prior to telecine). This disclosure also provides many useful details of inverse telecine techniques that can improve the inverse telecine process, e.g., by simplifying the inverse telecine process and by reducing memory accesses during the process.

In one example, this disclosure provides a method comprising determining whether individual video frames in a sequence of video frames are progressive frames or interlaced frames, identifying a pattern of the progressive frames and the interlaced frames in the sequence of video frames, identifying a telecine technique based on the pattern, and performing an inverse telecine technique with respect to the sequence of video frames based on the identified telecine technique, wherein the inverse telecine technique converts N video frames per second to M video frames per second, wherein M and N are positive integers and M is less than N.

In another example, this disclosure provides an apparatus comprising an inverse telecine unit that determines whether individual video frames in a sequence of video frames are progressive frames or interlaced frames, identifies a pattern of the progressive frames and the interlaced frames in the sequence of video frames, identifies a telecine technique based on the pattern, and performs an inverse telecine technique with respect to the sequence of video frames based on the identified telecine technique, wherein the inverse telecine technique converts N video frames per second to M video frames per second, wherein M and N are positive integers and M is less than N.

In another example, this disclosure provides a device comprising means for determining whether individual video frames in a sequence of video frames are progressive frames or interlaced frames, means for identifying a pattern of the progressive frames and the interlaced frames in the sequence of video frames, means for identifying a telecine technique based on the pattern, and means for performing an inverse telecine technique with respect to the sequence of video frames based on the identified telecine technique, wherein the inverse telecine technique converts N video frames per second to M video frames per second, wherein M and N are positive integers and M is less than N.

The techniques described in this disclosure may be implemented in hardware, software, firmware, or any combination thereof. If implemented in software, the software may be executed in a processor, such as a microprocessor, application specific integrated circuit (ASIC), field programmable gate array (FPGA), or digital signal processor (DSP). The software that executes the techniques may be initially stored in a computer-readable medium and loaded and executed in the processor.

Accordingly, this disclosure also contemplates a computer-readable medium comprising instructions that when executed by a processor cause the processor to determine whether individual video frames in a sequence of video frames are progressive frames or interlaced frames, identify a pattern of the progressive frames and the interlaced frames in the sequence of video frames, identify a telecine technique based on the pattern, and perform an inverse telecine technique with respect to the sequence of video frames based on the identified telecine technique, wherein the inverse telecine technique converts N video frames per second to M video frames per second, wherein M and N are positive integers and M is less than N.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF DRAWINGS

FIG. 1 is a conceptual diagram illustrating a telecine process where 3:2 pull down is applied to obtain 30 frames per second from 24 frames per second.

FIG. 2 is a conceptual diagram illustrating a telecine process followed by an inverse telecine process.

FIG. 3 is a block diagram illustrating an exemplary system that may implement on or more of the inverse telecine techniques of this disclosure.

FIG. 4 is a flow diagram illustrating an inverse telecine technique according to this disclosure.

FIG. 5 is a block diagram of an inverse telecine module.

FIG. 6 is a block diagram illustrating exemplary components of an inverse telecine unit.

FIG. 7 is a conceptual diagram illustrating film frames and telecined video frames.

FIG. 8 is a conceptual diagram illustrating a sequence of frames in which a telecine pattern is broken.

FIG. 9 is a conceptual diagram illustrating video frames being inverse telecined.

FIG. 10 is a conceptual diagram illustrating a sequence of five frames telecined according to 3:2 pull down.

FIG. 11 is a block diagram illustrating exemplary stages of an inverse telecine process.

FIG. 12 is a conceptual diagram of an interlaced video frame.

FIG. 13 is a flow diagram illustrating a process of identifying an out of phase video frame consistent with this disclosure.

FIG. 14 is a conceptual diagram illustrating features that may be used in the identification of an out of phase video frame.

FIG. 15 is a conceptual diagram illustrating difference sequences of out of phase and in phase video frames, which shading to show patterns consistent with telecine.

FIG. 16 is a conceptual diagram illustrating a process of creating a weaved from a current frame and a previous frame.

FIG. 17 is another block diagram of components of a device that may be used to perform inverse telecine consistent with this disclosure.

FIG. 18 is a flow diagram illustrating a process of setting telecine detection flags consistent with one or more aspects of this disclosure.

FIG. 19 is a flow diagram illustrating a process of setting telecine flag labels consistent with one or more aspects of this disclosure.

FIG. 20 is a flow diagram illustrating a process of identifying frame states consistent with one or more aspects of this disclosure.

FIG. 21 is a flow diagram illustrating a process for defining pattern IDs for frames consistent with one or more aspects of this disclosure.

FIG. 22 is a flow diagram illustrating a process of setting telecine pattern flags consistent with one or more aspects of this disclosure.

FIG. 23 is a flow diagram illustrating a process of determining frame states consistent with one or more aspects of this disclosure.

FIG. 24 is a state diagram illustrating expected frame state changes consistent with inverse telecine detection of 3:2 pull down.

FIG. 25 is a flow diagram illustrating a process of setting telecine detection flags consistent with one or more aspects of this disclosure.

FIG. 26 is a conceptual diagram illustrating the conversion of five frames to four frames in which correction occurs with respect to frames two and three of a five frame sequence.

FIG. 27 is a flow diagram illustrating an overview of telecine correction, and further showing one possibility of implementation.

FIG. 28 is a conceptual diagram illustrating several options for partial fetches of frames for purposes of telecine detection.

FIG. 29 is a conceptual diagram illustrating the decoding and display order of an “IBP” group of pictures (GOP) structure.

FIG. 30 is a conceptual diagram illustrating possible synchronization between inverse telecine data fetch and predictive decoding by a decoder for an IBP GOP structure like that illustrated in FIG. 30.

FIG. 31 is a conceptual diagram illustrating the decoding and display order an “IBBP” GOP structure.

FIG. 32 is a conceptual diagram illustrating possible synchronization between inverse telecine data fetch and predictive decoding by a decoder for an IBBP GOP structure like that illustrated in FIG. 34.

FIG. 33 is a flow diagram illustrating a deterministic fetch technique that may be used in inverse telecine consistent with this disclosure.

FIG. 34 is a flow diagram illustrating a technique for creating a block validity map useful for inverse telecine consistent with this disclosure.

FIG. 35 is an illustration of an exemplary block validity map useful for inverse telecine consistent with this disclosure.

FIG. 36 is a flow diagram illustrating a technique for analyzing a block validity map for inverse telecine consistent with this disclosure.

FIG. 37 is a flow diagram a technique for ranking and picking columns of a video frame for inverse telecine based on statistics generated from a block validity map.

FIG. 38 is an illustration of an exemplary partial block validity map that is adaptively generated as statistics become available.

### DETAILED DESCRIPTION

This disclosure describes techniques for detecting telecine and performing inverse telecine. Telecine is the process of converting the frame rate of a video sequence, and inverse telecine is the process of converting the frame rate back to the original rate. Telecine is commonly used to convert film which was shot at 24 frames per second to video at 30 frames per second (or 60 fields per second). Telecine is often performed by a procedure called 3:2 pull down, although other types of conversions could be used.

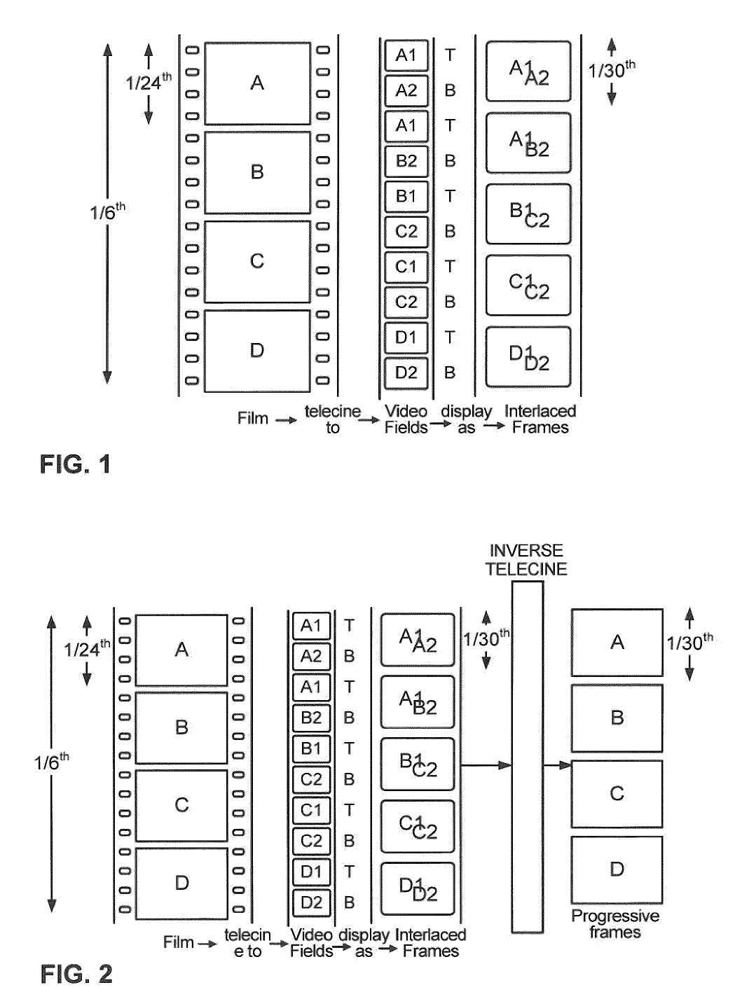

FIG. 1 is a conceptual diagram illustrating a telecine technique that uses 3:2 pull down. In this case, film that was recorded at 24 frames per second is telecined to a set of video fields that define 60 fields per second. Each field may comprise at least a portion of a frame. In particular, top field A1 comprises odd numbered lines of frame A, and bottom field A2 comprises even numbered lines of frame A. The fields are interlaced, as illustrated, to define video frames at 30 frames per second. In particular, fields A1 and A2 are interlaced to define a frame that is similar to frame A in the film. In interlacing, every other line of frame A is derived from fields A1 and A2 in an alternating manner. Fields Al and B2 are interlaced to define a frame that is an interlaced combination of frames A and B of the film, and fields B1 and C2 are interlaced to define a frame that is an interlaced combination of frames B and C of the film. Fields C1 and C2 are interlaced to define a frame that is similar to frame C of the film, and fields D1 and D2 are interlaced to define a frame that is similar to frame D of the film.

Inverse telecine is the process of reversing the telecine process, and is conceptually illustrated in FIG. 2. In 3:2 pull down, inverse telecine involves converting the video at 30 frames per second back to 24 frames per second (see FIG. 2). Inverse telecine may be a necessary part of video post-processing due to various spatial and temporal video quality benefits that the process can provide. Inverse telecine could also be a part of transcoder. For example after video is decoded, inverse telecine could be applied, and frame rate could be reduced (i.e., converted back to its original value, for example 24 frames per second). In this case, the video data is later re-encoded. Inverse telecine, in this case of transcoding may help to reduce the total bit rate, which can be beneficial for storage or transmission.

Inverse telecine algorithms, consistent with this disclosure, may analyze the frames and fields of a video sequence to determine the repeating fields, and therefore identify a particular pull down pattern. The inverse telecine techniques may use four fields in order to detect a pull down pattern and perform pull down correction. Similar techniques may use even more fields (e.g., ten fields) for telecine detection. However, the need to process such large amounts of data (e.g., four fields or five frames) may result in high power consumption and create challenges to video decoding.

This disclosure also provides methods that may reduce the pixel area that needs to be processed during inverse telecine by selecting necessary portions of a frame or field. The described techniques may be independent of the actual inverse telecine algorithm and can be used with any type of inverse telecine algorithm, including 3:2 pull down, as well as numerous other types of telecine. The described techniques may involve fetching a subset of the pixel data that might otherwise be needed from external memory, and thereby reducing the number of the memory accesses without degrading the performance of inverse telecine algorithm.

Again, telecine often refers to the process of converting film to video. Film refers to photographic material typically produced for the cinema. Film is commonly recorded at 24 frames per second. However, television defined by the National Television System Committee (NTSC), and other digital video broadcasts may define 30 frames per second for video. Therefore, in order to display film content on NTSC compliant televisions, the film is converted to video. The conversion process is referred to as telecine. In some cases, NTSC standard conventional television systems may operate at 60 interlaced fields per second (actually 59.94 fields per second) and for the film's motion to be accurately rendered on the NTSC video signal, telecine may be needed to convert the film frame rate from 24 fps to 30 fps (i.e., approximately 60 fields per second).

Simply transferring each film frame onto each video frame would result in a film running approximately 24.9 percent faster than intended. A better solution for telecine is to repeat some film frames periodically such as in the case of so-called “3:2 pull down” to prevent apparent speedup of the film when the film is shown at the 30 frame per second video frame rate.

3:2 pull down is one specific type of process of converting 24 fps film rate to 30 fps video rate. To convert the movie rate to TV rate, the 3:2 pull down repeats the film frames in a recurring 3:2 pattern, which can be seen in FIG. 1. The first step is to convert a set of four frames into 8 fields. This transforms 24 frames per second into 48 interlaced fields per second. Then, to account for the faster rate of the NTSC standard (i.e., 30 fps, or 60 fields per second), it is necessary to repeat certain fields, which is done in 3:2 pull down by adding an extra field every other frame.

The first film frame A may be separated into a top field (A1) and a bottom field (A2). Top field A1 comprises odd numbered lines, and bottom field A2 comprises even numbered lines. The top field A1 and the bottom field A2 define the first video frame as shown in FIG. 1. Portions of film frame B are repeated two times and are recorded as bottom field (B2) for second output video frame and top field (B1) for third output video frame. The different fields of third film frame C may also be repeated three times as bottom field C2, top field C1, and another bottom field C2, as shown in FIG. 1. Fields of fourth film frame D are repeated two times as bottom field D1 and top field D2. The third output frame is an interlaced version of B1 and C2, and the fourth output frame is an interlaced version of C1 and C2. The fifth output frame is an interlaced version of D1 and D2. By this process, an extra video frame is created per 4 input film frames. If this pattern is repeated six times, 24 frames of film become 30 frames of video.

Other pull down patterns also exist and are consistent with the teaching of this disclosure. A 2:3 pull down, for example, repeats the first film frame two times and the second film frame three times. Therefore, 2:3 pull down is very similar to 3:2 pull down except it is shifted by one frame.

2:2 pull down is another common pull down pattern. It may be used, for example, when converting the 24 frames per second film into a video that defines 48 fields per second. In 2:2 pull down each film frame is repeated twice and becomes 48 fields per second. This method results in speeding up the film and causes the film to run in slightly less time. A less common version of 2:2 pull down is called “2:2:2:2:2:2:2:2:2:2:2:3” pull down. This method inserts a repeated field every 12 frames, resulting in spreading 12 film frames over 25 fields of video and therefore converting 24 frames of film into 50 fields of video. Some motion pictures are telecined this “2:2:2:2:2:2:2:2:2:2:2:3” way. In addition to 3:2 and 2:2 pull down, less common cadences such as 5:5, 6:4 and 8:7 exist as well, and are sometimes used in Japanese animation. Other types of pull downs are also consistent with this disclosure.

Inverse telecine is used to reverse or “undo” the telecine process to regain the original content, e.g., at 24 frames per second. The inverse telecine technique of detection and removal of 3:2 pull down pattern from interlaced video sources to reconstruct 24 frames per second is called both “inverse telecine” or “reverse telecine.” An illustration of the inverse telecine following telecine is shown in FIG. 2. Inverse telecine may be necessary when displaying the interlaced content on high-quality non-interlaced displays. Furthermore, inverse telecine may be desirable in many other situations, such as in a transcoder device, or another device.

Inverse Telecine can be done in different ways. In some cases, the input telecined video is ingested with telecine information which shows the correspondence between the video frame and the original film frame. In these cases, the decoder (or player) device does not need to detect the pull down pattern but can play the video based on this information (which usually exists in the form of a telecine trace text file).

Another way of inverse telecine is to detect the pull down pattern and reverse it without prior knowledge of the pattern which is the basis of the techniques described herein. Sometimes, once the 3:2 pull down pattern is detected, it can be locked for the remainder of the video and the correction of the pattern can be done based on the initially detected pattern. However, the 3:2 pull down pattern does not necessarily remain consistent throughout the entire video, and edits can be performed on film material. So-called “bad edits” can happen when the editing process eliminates the film frame or more likely, inserts video material, such as commercials or new clips between them. A good inverse telecine algorithm should be able to identify when the 3:2 pull down pattern changes in the source and adaptively correct it. This is sometimes called “bad edit detection.”

The benefits of inverse telecine according to this disclosure may include visual quality improvements, and/or bandwidth and power savings, which will become more apparent from the description below. Specifically, inverse telecine may help to eliminate both spatial and temporal the artifacts in telecined content. If the telecined content is displayed in progressive displays without de-interlacing, combing artifacts may appear particularly at the boundaries of moving objects in a video sequence. However, if the telecined content is de-interlaced, blurring may occur. Furthermore, in addition to spatial artifacts, temporal artifacts such as motion judder may occur due to telecine. The motion judder is sometimes referred to as telecine judder, and may be particularly apparent during slow and steady camera movements. The motion judder is due to the fact that 2 fields out of every 10 fields are repeated during 3:2 pull down process.

Furthermore, some de-interlacing algorithms such as those which use temporal information bias the de-interlacing filtering towards reference (or previous) field to the extent the reference field is repeated and this causes jerkiness as well. On the other hand, “hiccup” like artifacts may occur in material in which 2:2:2:2:2:2:2:2:2:2:2:3 pull down has been applied. Hiccup is slightly different than motion judder and occurs about twice a second in the video.

The “hard telecine” means that pull down is applied before encoding. As opposed to hard telecine, “soft telecine” does not apply pull down before encoding, but rather treats the video as 24 P (wherein P stands for progressive). Soft telecine embeds the bitstream with proper pull down flags and pull down can be executed when displaying the content at interlaced display. It is also important to note that most SD-DVDs are in “hard telecine” mode, and therefore inverse telecine may be needed for both progressive and interlaced displays. In hard telecine, the video becomes 60/50 I (wherein I stands for interlaced) after pull down and is stored as 60/50 I content in video buffer in the same manner as normal interlaced content. The resulting video frames after pull down are used as reference frames for motion estimation and compensation.

In many video sequences, a 3:2 pull down process is applied to the 24 frames per second film source. The resulting 60 fields per second video can be encoded directly, or alternatively, commercials can be added to the video source and the resulting 60 fields per second video content can be encoded after editing. In this case, after the video player decodes the 60 fields per second of video content, the inverse telecine and bad edit detection techniques of this disclosure may be applied. Accordingly, if inverse telecine is detected and corrected, the true progressive 24 frames per second film is displayed. However, if telecine is not detected or does not exist (for example in the case where the input is purely interlaced content with no telecine applied to it), de-interlacing can be applied via a filter and the output device can display 30 frames per second of progressive video.

Inverse telecine is a fundamental post-processing feature. Inverse telecine may also be referred to as “film mode detection technology,” “film cadence and bad edit recovery,” “film mode detection,” and “reverse 3:2 pull down.” 3:2 pull down is widely accepted in the industry.

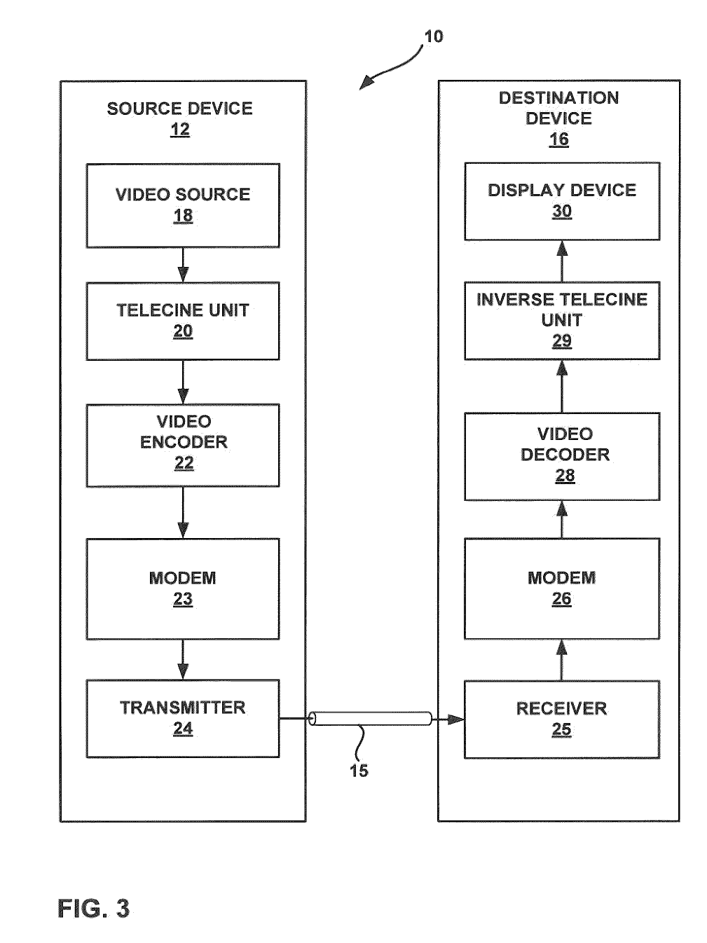

FIG. 3 is a block diagram illustrating one exemplary video encoding and decoding system 10 that may be used to implement one or more of the inverse telecine techniques of this disclosure. In the example of FIG. 3, inverse telecine unit 29 is located after video decoder 28. However, an inverse telecine unit consistent with this disclosure could also be used in many other locations or devices. For broadcasting applications, for example, the inverse telecine unit could be located before a video encoder to save bitrate prior to broadcast transmissions. In short, FIG. 3 is simply one example of a system that may implement one or more of the inverse telecine techniques of this disclosure.

As shown in FIG. 3, system 10 includes a source device 12 that transmits encoded video to a destination device 16 via a communication channel 15. Source device 12 and destination device 16 may comprise any of a wide range of devices. In some cases, source device 12 and destination device 16 comprise wireless communication devices, such as wireless handsets, so-called cellular or satellite radiotelephones, or any wireless devices that can communicate video information over a communication channel 15, in which case communication channel 15 is wireless. The techniques of this disclosure, however, which concern inverse telecine detection, memory access reductions, and power savings associated with inverse telecine, are not necessarily limited to wireless applications or settings. The techniques may also be useful in a wide rage of other settings and devices, including devices that communicate via physical wires, optical fibers or other physical or wireless media. In addition, the encoding or decoding techniques may also be applied in a stand alone device that does not necessarily communicate with any other device.

In the example of FIG. 3, source device 12 may include a video source 18, a telecine unit 20, a video encoder 22, a modulator/demodulator (modem) 23 and a transmitter 24. Telecine unit 20 may be referred to as “hard telecine.” Destination device 16 may include a receiver 25, a modem 26, a video decoder 28, an inverse telecine unit 29, and a display device 30. In accordance with this disclosure, inverse telecine unit 29 of destination device 16 may be configured to apply one or more of the techniques of this disclosure as part of a video decoding process, although inverse telecine techniques, consistent with this disclosure, might also be applied without regard to video decoding.

Again, the illustrated system 10 of FIG. 3 is merely exemplary. The various techniques of this disclosure may be performed by any device that supports inverse telecine. Destination device 16 is merely one examples of such a device within a system 10 in which source device 12 generates coded video data for transmission to destination device 16. In some cases, devices 12, 16 may operate in a substantially symmetrical manner such that, each of devices 12, 16 include video encoding and decoding components. Hence, system 10 may support one-way or two-way video transmission between video devices 12, 16, e.g., for video streaming, video playback, video broadcasting, or video telephony.

Video source 18 of source device 12 may include a video capture device, such as a video camera, a video archive containing previously captured video, or a video feed from a video content provider. As a further alternative, video source 18 may generate computer graphics-based data as the source video, or a combination of live video, archived video, and computer-generated video. In some cases, if video source 18 is a video camera, source device 12 and destination device 16 may form so-called camera phones or video phones. In each case, the captured, pre-captured or computer-generated video may be telecined by telecine unit 20, and encoded by video encoder 22. The encoded video information may then be modulated by modem 23 according to a communication standard, e.g., such as code division multiple access (CDMA) or another communication standard, and transmitted to destination device 16 via transmitter 24 and communication channel 15. Modem 23 may include various mixers, filters, amplifiers or other components designed for signal modulation. Transmitter 24 may include circuits designed for transmitting data, including amplifiers, filters, and one or more antennas.

Receiver 25 of destination device 16 receives information over communication channel 15, and modem 26 demodulates the information. Like transmitter 24, receiver 25 may include circuits designed for receiving data, including amplifiers, filters, and one or more antennas. In some instances, transmitter 24 and/or receiver 25 may be incorporated within a single transceiver component that include both receive and transmit circuitry. Modem 26 may include various mixers, filters, amplifiers or other components designed for signal demodulation. In some instances, modems 23 and 26 may include components for performing both modulation and demodulation. Video decoder 28 performs block based video decoding, e.g., the reconstruct the encoded video blocks that were encoded by video encoder 22. Inverse telecine unit 29 then performs inverse telecine with respect to the decoded video.

The inverse telecine process performed by destination device 16 may be performed during video decoding, although aspects of this disclosure might also be performed without block-based video decoding. In particular, inverse telecine unit 29 may perform the inverse telecine techniques, as described herein, to convert the frame rate of a video sequence back to the original film rate (e.g., to “undo” the telecine performed by telecine unit 20 of source device 12).

More specifically, inverse telecine unit 29 may determine whether individual video frames in a sequence of video frames are progressive frames or interlaced frames, identify a pattern of the progressive frames and the interlaced frames in the sequence of video frames, identifying a telecine technique based on the pattern, and perform an inverse telecine technique with respect to the sequence of video frames based on the identified telecine technique. In this case, the inverse telecine technique converts N video frames per second to M video frames per second, wherein M and N are positive integers and M is less than N. Accordingly, inverse telecine reduces the frame rate back to the original film rate associated with the video sequence as it was originally recorded onto film media.

Video decoder 28 may include motion estimation and motion compensation components for temporal-based decoding. In addition, video decoder 28 may include spatial estimation and intra coding units for spatial-based decoding. Display device 30 displays the decoded video data to a user following the inverse telecine process, and may comprise any of a variety of display devices such as a cathode ray tube (CRT), a liquid crystal display (LCD), a plasma display, an organic light emitting diode (OLED) display, or another type of display device.

In the example of FIG. 3, communication channel 15 may comprise any wireless or wired communication medium, such as a radio frequency (RF) spectrum or one or more physical transmission lines, or any combination of wireless and wired media. Communication channel 15 may form part of a packet-based network, such as a local area network, a wide-area network, or a global network such as the Internet. Communication channel 15 generally represents any suitable communication medium, or collection of different communication media, for transmitting video data from source device 12 to destination device 16. Communication channel 15 may include routers, switches, base stations, or any other equipment that may be useful to facilitate communication from source device 12 to destination device 16.

Video encoder 22 and video decoder 28 may operate according to a video compression standard, such as the ITU-T H.264 standard, alternatively described as MPEG-4, Part 10, Advanced Video Coding (AVC). The techniques of this disclosure, however, are not limited to any particular video coding standard. Although not shown in FIG. 1, in some aspects, video encoder 22 and video decoder 28 may each be integrated with an audio encoder and decoder, and may include appropriate MUX-DEMUX units, or other hardware and software, to handle encoding of both audio and video in a common data stream or separate data streams. If applicable, MUX-DEMUX units may conform to the ITU H.223 multiplexer protocol, or other protocols such as the user datagram protocol (UDP).

The various components of source device 12, and destination device 16, including inverse telecine unit 29 of destination device 16 may be implemented as one or more microprocessors, digital signal processors (DSPs), application specific integrated circuits (ASICs), field programmable gate arrays (FPGAs), discrete logic, software, hardware, firmware or any combinations thereof. Telecine unit 20 and inverse telecine unit 29 may be incorporated within video encoder 22 and video decoder 28, respectively. Again, the inverse telecine techniques of this disclosure may be implemented as part of a video decoding process, but may also be used in other settings and scenarios. Furthermore, after inverse telecine operations, the video data does not necessarily need to be displayed. In other examples, following inverse telecine, the video data may be re-encoded (for example in a transcoding scenario), and the new encoded video data can either be stored for future playback or can be transmitted for broadcasting applications.

A video sequence typically includes a series of video frames. Video encoder 22 operates on video blocks within individual video frames in order to encode the video data. The video blocks may have fixed or varying sizes, and may differ in size according to a specified coding standard. Each video frame includes a series of slices. Each slice may include a series of macroblocks, which may be arranged into sub-blocks. As an example, the ITU-T H.264 standard supports intra prediction in various block sizes, such as 16 by 16, 8 by 8, or 4 by 4 for luma components, and 8×8 for chroma components, as well as inter prediction in various block sizes, such as 16 by 16, ≠by 8, 8 by 16, 8 by 8, 8 by 4, 4 by 8 and 4 by 4 for luma components and corresponding scaled sizes for chroma components. Video blocks may comprise blocks of pixel data, or blocks of transformation coefficients, e.g., following a transformation process such as discrete cosine transform (DCT) or a conceptually similar transformation process. According to the techniques of this disclosure, video encoder 22 and video decoder 28 operate in the telecined domain, e.g., following telecine performed by unit 20. In another scenario, an encoder could be applied after inverse telecine unit 29, and in this case, the encoder may operate in non-telecine domain.

Smaller video blocks can provide better resolution, and may be used for locations of a video frame that include high levels of detail. In general, macroblocks and the various sub-blocks may be considered to be video blocks. In addition, a slice may be considered to be a series of video blocks, such as macroblocks and/or sub-blocks. Each slice may be an independently decodable unit of a video frame. Alternatively, frames themselves may be decodable units, or other portions of a frame may be defined as decodable units. The term “coded unit” refers to any independently decodable unit of a video frame such as an entire frame, a slice of a frame, or another independently decodable unit defined according to the coding techniques used.

To encode the video blocks, video encoder 22 performs intra- or inter-prediction to generate a prediction block. Video encoder 22 subtracts the prediction blocks from the original video blocks to be encoded to generate residual blocks. Thus, the residual blocks are indicative of differences between the blocks being coded and the prediction blocks. Video encoder 22 may perform a transform on the residual blocks to generate blocks of transform coefficients. Following intra- or inter-based predictive coding and transformation techniques, video encoder 22 performs quantization. Quantization generally refers to a process in which coefficients are quantized to possibly reduce the amount of data used to represent the coefficients. Following quantization, entropy coding may be performed according to an entropy coding methodology, such as context adaptive variable length coding (CAVLC) or context adaptive binary arithmetic coding (CABAC).

In destination device 16, video decoder 28 receives the encoded video data, and entropy decodes the received video data according to an entropy coding methodology, such as CAVLC or CABAC, to obtain the quantized coefficients. Video decoder 28 applies inverse quantization (de-quantization) and inverse transform functions to reconstruct the residual block in the pixel domain. Video decoder 28 also generates a prediction block based on control information or syntax information (e.g., coding mode, motion vectors, syntax that defines filter coefficients and the like) included in the encoded video data. Video decoder 28 sums the prediction block with the reconstructed residual block to produce a reconstructed video block for display.

According to the techniques of this disclosure, inverse telecine unit 29 may determine whether individual video frames in a sequence of video frames are progressive frames or interlaced frames, identify a pattern of the progressive frames and the interlaced frames in the sequence of video frames, identifying a telecine technique based on the pattern, and perform an inverse telecine technique with respect to the sequence of video frames based on the identified telecine technique. In this case, the inverse telecine technique converts N video frames per second to M video frames per second, wherein M and N are positive integers and M is less than N. Accordingly, inverse telecine reduces the frame rate back to the original film rate associated with the video sequence as it was originally recorded onto film media.

Furthermore, inverse telecine unit 29 may leverage the fact that video decoder 28 has already loaded certain video data as part of the decoding process. That is, memory loads of data for purposes of video decoding by video decoder 28 may be used to reduce unnecessary duplicative memory loads of the same data, if such data is also needed for the inverse telecine process performed by inverse telecine unit 29. In this way, memory loads associated with inverse telecine unit 29 may be reduced, conserving power and memory bandwidth.

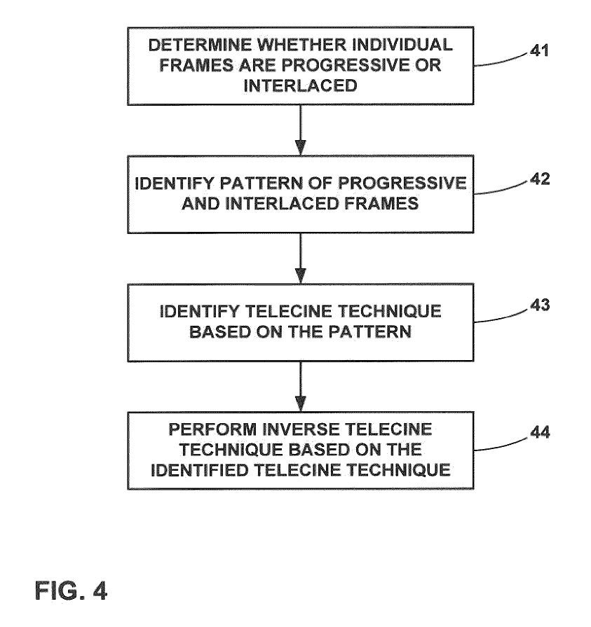

FIG. 4 is a flow diagram illustrating an inverse telecine technique consistent with this disclosure. As shown in FIG. 4, inverse telecine unit 29 determines whether individual video frames in a sequence of video frames are progressive frames or interlaced frames (41). Inverse telecine unit 29 then identifies identifying a pattern of the progressive frames and the interlaced frames in the sequence of video frames (42), and identifies a telecine technique based on the pattern (43). For example, if inverse telecine unit 29 identifies a repeating pattern of frames (e.g., a repeating pattern of P I I P P frames or P P I I P frames), then inverse telecine unit 29 may identify 3:2 pull down as being the telecine technique that was originally performed to define the frames. Inverse telecine unit 29 can then perform an inverse telecine technique with respect to the sequence of video frames based on the identified telecine technique (44). The inverse telecine technique converts N video frames per second to M video frames per second, wherein M and N are positive integers and M is less than N.

For 3:2 pull down, for example, the inverse telecine technique converts 30 video frames per second to 24 video frames per second by converting each pattern of five frames (P, P, I, I, P) into a pattern of four progressive frames (P, P, P, P), or each pattern of five frames (P, I, I, P, P) into a pattern of four progressive frames (P, P, P, P). In either case, when a pattern is associated with a 3:2 pull down telecine technique, identifying the pattern comprises identifying five frame sequences that consist of three progressive frames and two interlaced frames. For PPIIP, there would be two progressive frames followed by two interlaced frames followed by one progressive frame, whereas for PIIPP, there would be one progressive frame followed by two interlaced frames followed by two progressive frames. In either case, performing the inverse telecine technique may comprise converting the five frame sequences to four frame sequences, wherein the inverse telecine technique converts 30 video frames per second to 24 video frames per second.

In identifying whether individual video frames in the sequence of video frames are progressive frames or interlaced frames, telecine unit 29 may process only a subset of data associated with the individual video frames. Additional details of how this subset can be defined are provided below. Generally, the subset may comprise a block of pixel data within the individual frames, wherein the block is pre-defined for inverse telecine detection, and wherein the block of pixel data is fetched from memory for each of the individual frames. The subset may comprise vertical columns of pixel data within the individual frames, wherein the vertical columns of pixel data within the individual frames are pre-defined for inverse telecine detection, and wherein the vertical columns of pixel data within the individual frames are fetched from memory for each of the individual frames.

In some cases, the subset of data processed for purposes of inverse telecine may comprise vertical columns of pixel data within the individual frames, wherein the vertical columns of pixel data within the individual frames are adaptively defined based on whether data has already been fetched from memory for use in predictive video coding. In other cases, the subset associated with any given frame may be adaptively defined based on whether data has already been fetched from memory for use in predictive video coding. As outlined in greater detail below, for example, inverse telecine unit 29 may generate a map of pixels associated with a respective frame to define whether data has already been fetched from memory for use in predictive video coding, and define the subset for the respective frame based on the map. To further simplify processing, inverse telecine unit 29 may generate a partial map of pixels associated with a respective frame to define whether data has already been fetched from memory for use in predictive video coding, and define the subset for the respective frame based on the partial map, wherein the partial map is defined during video coding of the respective frame as statistics become available, wherein the statistics define whether individual pixels have already been fetched for the video coding. In either case, the map may pinpoint useful data that is already stored for purposes of video decoding by decoding unit 28, thus eliminating the need for inverse telecine unit 29 to fetch that same data again.

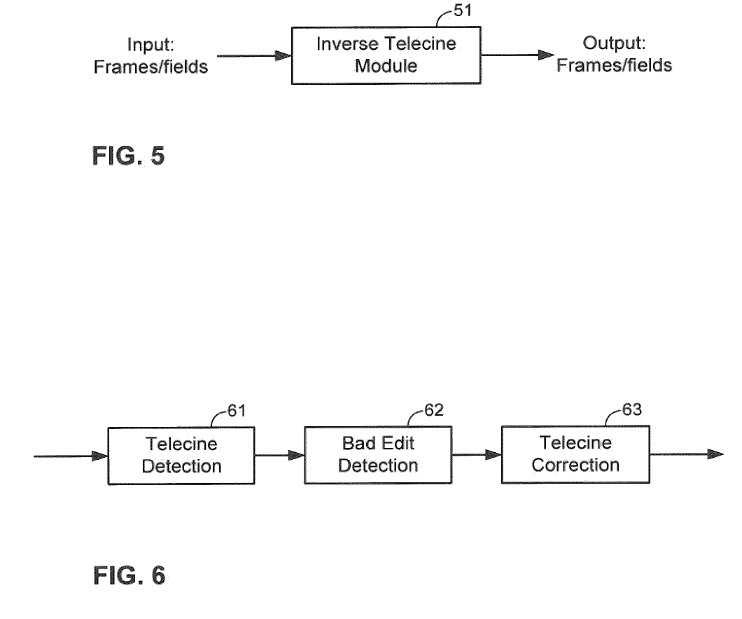

There are many algorithms proposed for inverse telecine process. The focus of this disclosure is an inverse telecine process that does not require information in the bitstream to identify the telecine technique that was used. In addition, another focus of this disclosure is memory bandwidth reduction during the inverse telecine process. FIG. 5 is a block diagram of an inverse telecine module 51, which may correspond to inverse telecine unit 29 of FIG. 3, or may correspond to a module or unit of another device. Inverse telecine module 51 receives input frames or fields and outputs output frames, where the frame rate changes from input to output. In particular, the frame rate typically reduces from input to output in inverse telecine.

Inverse telecine module 51 may analyze the input frames, perform telecine detection and do a correction based on the pattern identified during detection stage. Telecine detection algorithms may be classified based on the number of input fields or frames used for identifying the pull down pattern. The number of fields used in telecine detection algorithms is usually 2, i.e., top and bottom fields of a video frame. However, algorithms may use 4 fields (i.e., top and bottom fields of two different frames) in telecine detection. Other numbers of fields, e.g., 5 or more input fields, could also be defined.

The processing of such large amounts of data, however, can require high power and resources. A telecine algorithm may conduct a zig-zag scan of a frame to reduce the amount of pixels to be processed. Furthermore, in order to reduce the number of operations performed by inverse telecine module 51, techniques that “disable inverse telecine once the telecine pattern is locked” could be executed by inverse telecine module 51. In this case, once the telecine pattern is found, the pattern is locked, and therefore, inverse telecine module 51 does not need to continue accessing new input frames, which may reduce processing power and bandwidth. However, this type of approach does not reduce the input pixel data that is used by inverse telecine module, 51, but rather, it reduces the number of times that inverse telecine module 51 operates. Accordingly, this type of technique may miss telecine pattern changes that can happen during bad-editing.

The techniques of this disclosure propose an effective algorithm to identify the pixel data to fetch for telecine detection. The advantages of the techniques of this disclosure may include a reduction in the amount of pixels used in inverse telecine process, which may reduce memory bandwidth without degrading inverse telecine performance. In addition, by reducing the amount of data traffic from memory and processing cycles, the described techniques may help to support application of inverse telecine to higher resolutions of video such as high-definition applications. The described techniques do not require any information to be conveyed in the bitstream to identify telecine, rather, telecine is detected purely on the content of the video.

For devices wherein power consumption is a concern (such as wireless devices), the described inverse telecine techniques may help to process more frames for telecine detection relative to other techniques that use similar amounts of power, which in turn helps to catch bad editing that happens during insertion of commercials and scene cuts. The memory bandwidth and power conservation aspects of this disclosure may be independent of the telecine detection algorithm and may be used with other telecine detections algorithms that require access to at least two fields (e.g., even and odd fields) of a frame. In this case, advantages may be achieved by fetching only portions of pixel data, where the portions of pixel data are determined adaptively by compressed domain statistics, or deterministically by vertical sampling approaches described in greater detail below. The moving parts of a picture are usually better indicators for telecine detection. Therefore, performing inverse telecine with respect to regions of interest that have high levels of motion may provide good telecine detection performance while decreasing memory bandwidth. Furthermore, the techniques of this disclosure may utilize available pixel data already fetched to an internal memory during video decoding by tracking motion vectors and the reference pictures identified by motion vectors.

The two major aspects of inverse telecine techniques are “telecine detection” (i.e., pull down detection) and “telecine correction.” In addition to these, “bad edit detection” may also be part of inverse telecine technique. FIG. 6 is a basic block diagram of a telecine detection unit 61 that includes a telecine detection stage 61, a bad edit detection stage 62, and a telecine correction stage 63.

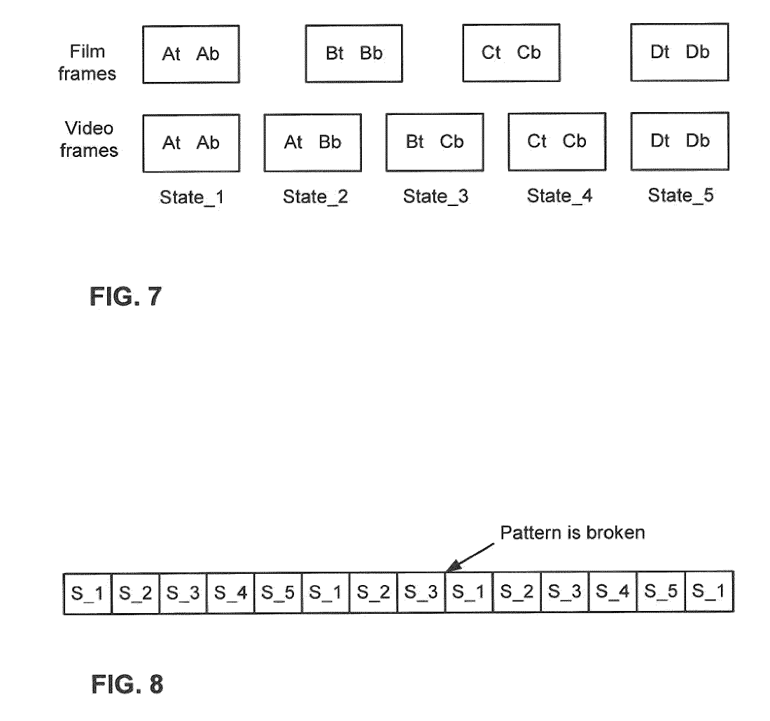

The basic goal of telecine detection 61 is to find out whether the interlaced video has gone through a 3:2 pull down, a 2:2 pull down, or another pull down process. The “states” of frames refer to the order of video frames as shown in FIG. 7 and the states may carry the information of which film frames make up a video frame. For example, State_2 means that, the second video frame in a group of five is composed of the top field of first film frame and bottom field of the second film frame. Similarly, State_4 means that the fourth video frame in a group of five is composed of the top and bottom field of the third film frame.

The goal of bad edit detection 62 may be to determine whether the initially identified pull down pattern is broken in time or not. A broken pull down pattern is illustrated in FIG. 8 for demonstration. If the pattern is broken as shown by the arrow in FIG. 8, the starting point of the new pull down pattern has to be identified, as well as the new states of the next video frames. A broken pattern associated with 3:2 pull down is illustrated in FIG. 8.

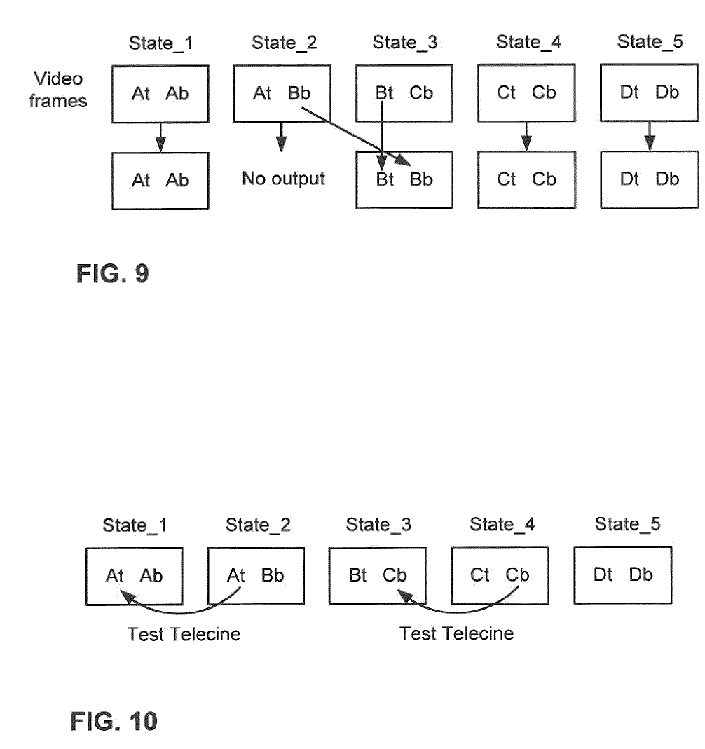

The goal of telecine correction 63 is to convert video frames into film frames by using the state information provided by the telecine detection as shown in FIG. 9. The correction may be a relatively straightforward process once the video frame states are correctly identified by telecine detection stage 61. In particular, as shown in FIG. 9, the correction may be performed according to the state information. For example, if the video frame is identified as State_1, State_4 or State_5, there is no change necessary. If the video frame is in State_2, the frame is dropped for correction. If the video frame is in State_3, it is corrected by fetching the bottom field from the previous video frame and dropping the bottom field of the current video frame. This correction is illustrated in FIG. 9.

Telecine detection algorithms may be classified based on the number of fields they use for identifying the pull down pattern. The minimum number of fields used in telecine detection algorithms is 2, e.g., top and bottom fields of a video frame, although more fields may be used. Telecine detection algorithms can also be classified based on the metric that is used in detection process. The following metrics listed below, for example, could be used for telecine detection:
Sum of Absolute Difference (SAD)
Absolute SAD
Pixel block parameters
Pixel statistics
Motion

The basis of some telecine algorithms is pixel differencing, e.g., using the SAD metric. SAD may be calculated between corresponding fields of two frames to identify whether a particular field is repeated or not. For example, referring to FIG. 9, a video frame in State_2 has the same top field as the video frame in State_1. By performing SAD between these two top fields, and thresholding the SAD value, it is possible to identify whether the top fields are repeated or not.

Pixel block parameters may also be used for telecine algorithms. The parameters may include content information such as the edges in a particular block of pixels. This metric is different from SAD in the sense that it measures content change instead of pixel value change. Using pixel statistics is similar to block parameter approach, where a comparison is made between two fields by using the mean and variance of a set of pixels.

Bad edit detection is not usually emphasized in telecine detection. Some algorithms may assume different pull down patterns, but this is usually not preferred. Different telecine detection algorithms may differ in terms of the number and choice of reference fields that they use in detection and the metric they use. Various aspects of this disclosure, particularly the memory bandwidth reduction aspects, may be used with a variety of inverse telecine algorithms.

In one type of inverse telecine algorithm, the SAD metric may be used in order to identify telecine detection. In this case, SAD is calculated between the same parity fields of two consecutive frames. If the SAD value of one field is greater than a preset threshold, the SAD value of the opposite field is also calculated. If the SAD value is comparable to the SAD value of opposite field, no telecine is detected. On the other hand, if the SAD value of opposite field is smaller, “Out_of_phase” is identified. If out_of_phase is detected consecutively during State_2 and State_4, the telecine pattern may be locked. Note that in the context of this algorithm, out_of_phase refers to interlaced video frame where either the top or bottom field of the video frame comes from previous video frame. In a group of five video frames that has gone through 3:2 pull down detection, out_of_phase should be detected twice: (i) between State_2 and State_1, (ii) between State_4 and State_3. FIG. 10 illustrates such out of phase detection for inverse telecine.

In all, 2 frames, i.e., 4 fields may be used in this type of inverse telecine algorithm. However, SAD may be calculated by using only a part of the pixels in a frame, as outlined in greater detail herein. The image may be scanned in zigzag fashion and only a small part of the image may be used. SAD implementation may be done in an 8-bit architecture. After locking the telecine pattern and detecting the State_2 followed by State_4 and then State_2, the algorithm may perform telecine correction, and output the reverse telecine content. The output may be interrupted any time when the telecine pattern fails at State_2 and State_4. The video frames are outputted as they are (i.e., no correction or change) for the following cases:
If no telecine is detected,
If there is not enough telecine history,
If the telecine pattern is interrupted.

Various memory bandwidth reduction aspects of this disclosure (which are addressed in greater detail below) may be applicable to any of these exemplary inverse telecine approaches. At this point, however, this disclosure will focus on a proposed inverse telecine technique that implements “telecine detection” and “telecine correction” modules or units.

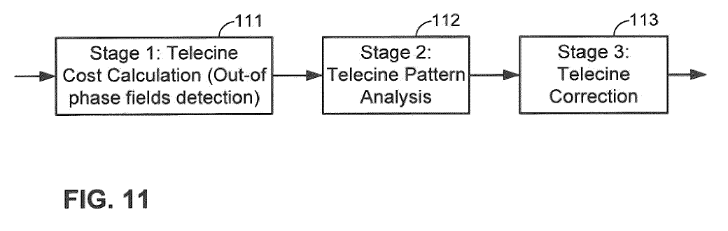

In this case, telecine detection may be carried out by two major stages: telecine cost calculation and telecine pattern analysis. A third stage (telecine correction), may also form part of the inverse telecine algorithm. FIG. 11 is a basic flow diagram illustrating these three stages. Cost calculation unit 111 performs analysis by using pixels from odd and even fields of a frame. The result of this analysis determines whether a video picture is a true progressive picture or a true interlaced picture. The output of cost calculation stage 111 may be used by telecine pattern analysis unit 112. The telecine pattern analysis may be implemented in hardware, firmware and/or software. The telecine pattern analysis unit 112 analyzes the input pattern and checks whether it matches with a standard 3:2 or 2:2 pull down pattern. If it matches, then the telecine pattern may be locked and the state information of each picture can be calculated. The state information dictates whether the telecine correction unit 113 will pixel fetch for telecine correction.

Telecine cost calculation unit 111 may use 2 fields (i.e., even and odd fields) of a picture. When compared to other algorithms which use more than 2 fields, this type of telecine cost calculation has advantages in terms of fulfilling low memory bandwidth requirements when implemented in resource constraint environments.

Even though the proposed algorithm is designed to detect 3:2 and 2:2 pull down patterns, it could easily be adjusted and used to detect other pull down patterns. The pattern analysis stage of unit 112 can be easily modified to detect other pull down patterns if necessary.

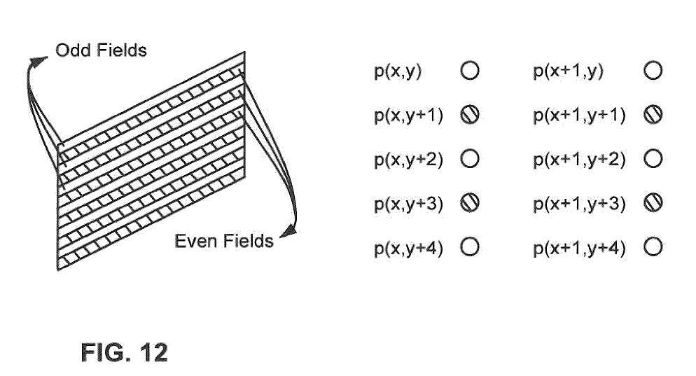

The “cost” in telecine cost calculation unit 111 may indicate the “number of columns that are detected as out-of-phase,” where “out-of-phase” means that even and odd fields in a picture are coming from different time instants. Out-of-phase data indicates interlacing. The goal of cost calculation algorithm is basically to identify whether a picture is interlaced or progressive. FIG. 12 is a conceptual diagram illustrating a telecined interlaced frame, wherein the odd fields and even fields identify pixel data coming from different frames.

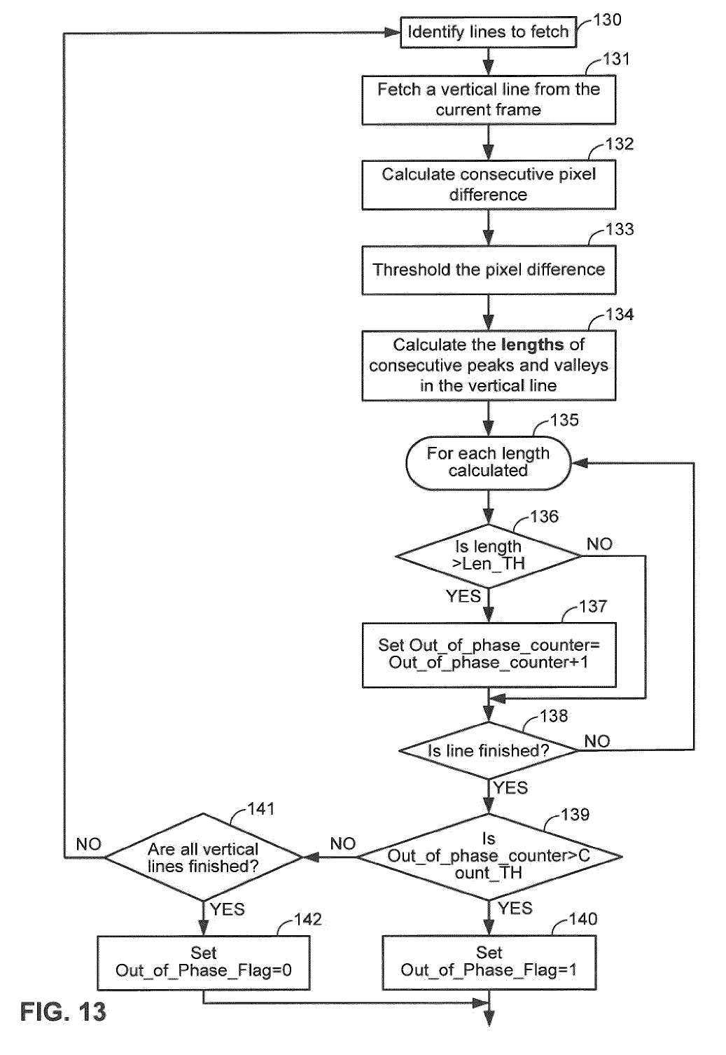

FIG. 13 is a flow diagram illustrating a process that may be performed by a telecine cost calculation unit, such as telecine cost calculation unit 111 shown in FIG. 12. As shown in FIG. 12, telecine cost calculation unit 111 identifies lines to fetch (130) and fetches a vertical line from the current frame, e.g., from memory (not shown) (131). Telecine cost calculation unit 111 calculates a consecutive pixel difference (132), and thresholds the pixel difference (133). Telecine cost calculation unit 111 next calculates the lengths of the consecutive peaks and valleys in the vertical line (134).

For each length calculated (135), telecine cost calculation unit 111 determines whether the length is greater than a length threshold Len_TH (136). If so (“yes” 136), telecine cost calculation unit 111 increments an out_of_phase_counter (137), and then determines whether the line is finished (138). Telecine cost calculation unit 111 may repeat this process for every pixel in the line, incrementing the out_of_phase_counter each time a given length is greater than the length threshold. Once the line is finished, telecine cost calculation unit 111 determines whether the out_of_phase_counter is greater than a count threshold count_TH (139). If so (“yes” 139), telecine cost calculation unit 111 sets an Out_of_Phase flag to 1 (140). If not (“yes” 139), telecine cost calculation unit 111 determines whether all vertical lines are finished (141).

If more vertical lines need to be considered, (“no” 141), telecine cost calculation unit 111 repeats the process for such lines. However, if telecine cost calculation unit 111 determines whether the out_of_phase_counter is less than a count threshold count_TH (“no” 139) and that all vertical lines are finished (“yes” 141), telecine cost calculation unit 111 sets the Out_of_Phase flag to 0. In this example, the Out_of_Phase flag being 0 means that the frame is progressive, while the Out_of_Phase flag being 1 means that the frame is interlaced.

The algorithm shown in the flow diagram of FIG. 13 can scan and process the pixel values column-wise. First a vertical line (i.e., column of a picture) is fetched. Then, difference of consecutive pixels in the column is calculated as follows:

d(x, y)=p(x, y)−p(x, y+1) (equation 1)

d(x, y+1)=p(x, y+1)−p(x, y+2) (equation 2)

Next the pixel difference is thresholded with the following equation:

$$t ( x , y ) = \{ \begin{matrix}1 & d ( x , y ) > th\_p \\ - 1 & d ( x , y ) < - th\_p\end{matrix} \qquad ( equation 3 )$$

where t(x,y) in Equation (3) represents a peak if it is equal to 1 and valley if it is −1.

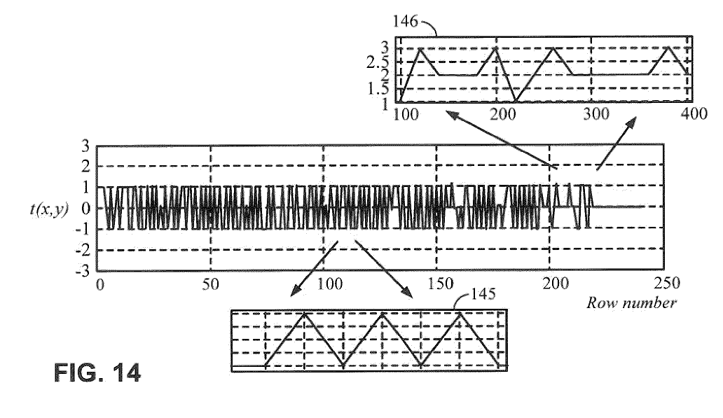

In order to avoid the effect of noise in peak-valley determination, telecine cost calculation unit 111 may use a pixel threshold th_p. The intuition behind the algorithm can be explained as follows. If a picture is interlaced, the odd and even fields will have high correlation with each other and similar pixel values. When they are interleaved, as shown in FIG. 12, the consecutive pixels in vertical direction of a picture column will have alternating pixel values. The difference of pixel intensities in vertical direction will look like a saw-tooth pattern. The saw-tooth pattern will be very significant if there is a motion between even and odd fields, whereas it will be less significant in stationary areas. An example of the saw-tooth pattern for an interlaced test sequence is shown in FIG. 14 at 145. In particular, pattern 145 shows significant peak and valleys, which corresponds to movement in a picture. However, there is no significant peak and valley pattern in another portion of the figure which corresponds to the background area, and this lack of peaks and valleys is illustrated at 146.

After determining peaks and valleys, the length of consecutive peak and valleys can be calculated as follows:

for (y=1: number of rows){ if(|t(x,y)−t(x,y+1)|==2) length(y)++; else length(y)=0; } (equation 4)

If the length of consecutive peaks and valleys is above a threshold (len_th), the column is identified as out_of_phase and an out_of_phase counter is increased. The len_th is adjusted based on the resolution of the image.

if (length(y)>(len_{—}th)) the out_of_phase_counter(t) is incremented. (equation 5)

Then, as a final step, the number of columns detected as out_of_phase may be compared against a threshold. If the number of columns detected as out_of_phase is larger than count_th, the whole picture may be identified as out_of_phase and represented with the binary label “1”. If the number of out_of_phase columns is less than a threshold, the picture is identified as in_phase and represented by the binary label “0.” In other words:

if (out_of_phase_counter(t)>(count_th)) picture_label(t)=1; else picture_label(t)=0; (equation 6)

In some implementations, early termination of the process may be possible both in column and in picture level. In column level early termination, once the length of consecutive peaks and valleys exceed the threshold len_th, the algorithm may stop processing the current column and move to the next column. In picture level early termination, once some percent threshold (e.g., count_th) is reached, it may be unnecessary to check the subsequent columns.

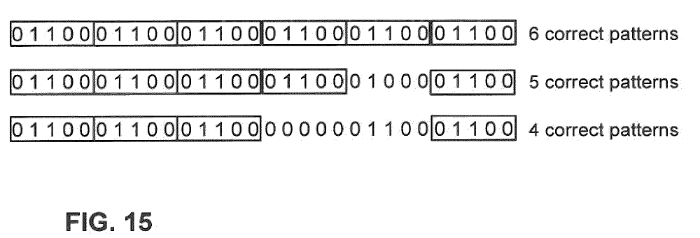

Telecine pattern analysis unit 112 may analyze the picture_label information of consecutive pictures and identify whether the input video has 3:2 or 2:2 pull down pattern or not. Furthermore, telecine pattern analysis unit 112 may determine the state information of each frame based on the starting state of the pull down pattern. A correct 3:2 pull down pattern and the picture labels are shown in FIG. 15. In particular, the correct 3:2 pull down pattern may be represented by the following bit pattern:

CPD_{—}32=[1 1 0 0 0 1 1 0 0 0 1 1 0 0 0 1 1 0 0 0 1 1 0 0 0 1 1 0 0 . . . ] (equation 7)

It can be seen from equation 8 above that [0 1 1 0 0] is the basic bit pattern that repeats itself in CPD_32. Note that the pattern can be shifted and can start from the 2^{nd} or 3^{rd} column of CPD_32. Although equation 7 may represent the most common pattern, there is no standard specifying the offset value of the pull down pattern. Therefore, it may be necessary to consider all possible offsets to correctly detect the pull down pattern. An example of the same 3:2 pull down pattern with an offset of 2 is presented below.

CPD_{—}32=[1 0 0 0 1 1 0 0 0 1 1 0 0 0 1 1 0 0 0 1 1 0 0 0 1 1 0 0 0 1 . . . ] (equation 8)

Mathematically, one may find a correct pattern if the following equation is satisfied:

If ([picture_label(t−4) picture_label(t−3) picture_label(t−2) picture_label(t−1) picture_label(t)]=Pattern_ID(1)∥Pattern_ID(2)∥Pattern ID(3)∥Pattern ID(4)∥Pattern_ID(5)) set Picture_ID=get_ID(Pattern_ID); (equation 9)

Where t represents time, ∥ is OR operation and Pattern_ID's with different offsets are given below.

1=Pattern_ID(1)=[0 1 1 0 0]

2=Pattern_ID(2)=[1 1 0 0 0]

3=Pattern_ID(3)=[1 0 0 0 1]

4=Pattern_ID(4)=[0 0 0 1 1]

5=Pattern_ID(5)=[0 0 1 1 0] (equation 10)

Typically the algorithm can find the first 3:2 pull down pattern as early as the fifth frame. However, it may be desirable to lock the 3:2 pull down pattern if four basic patterns are found out of 6 patterns (i.e., after 30^{th} frame) as shown in each of the three examples of FIG. 15. If the pattern is locked early there is a risk of incorrect Telecine detection, which in turn could affect the telecine correction and ultimately result in bad video quality.

Once the pull down pattern is locked, the state of each picture may be identified. The state of each picture can be found easily by table lookup method as shown in Table 1, below.

TABLE 1
Determining Picture States

| | | | | | |
|---|---|---|---|---|---|
| Picture ID | 1 = [0 1 1 0 0] | 2 = [1 1 0 0 0] | 3 = [1 0 0 0 1] | 4 = [0 0 0 1 1] | 5 = [0 0 1 1 0] |
| Picture | State_5 | State_1 | State_2 | State_3 | State_4 |
| State | | | | | |

A 2:2 (i.e., 2:2:2:2:2:2:2:2:2:2:2:3) pull down pattern detection procedure may be similar to the 3:2 pull down case. The difference is that 2:2 pull down has a particular correct pull down pattern (shown in equation 11), and the lock time is longer since a basic 2:2 pattern is larger in length compared to 3:2 pull down basic pattern.

CPD_{—}22=[0 0 0 0 0 0 0 0 0 0 0 0 1 1 1 1 1 1 1 1 1 1 1 1 0 0 0 0 0 0 0 0 0 0 0 0 1 1 1 1 1 1 1 1 1 1 1 1 1 . . . ] (equation 11)

Parameters such as “the number of patterns checked” and “the correct pull down pattern” can be easily modified in different implementations.

Telecine Correction unit 113 converts video frames into film frames by using the state information provided by the telecine detection, which is performed by telecine cost calculation unit 111 and telecine pattern analysis unit 112. Telecine correction is relatively a straightforward process once the video frame states are correctly identified by the telecine detection process. Telecine correction is done at the time frames are fetched for display. Simply, one frame may be discarded out of very five frames during telecine correction, and in this way 24 frames per second may be obtained from 30 frames per second of video.

Telecine detection may involve storing a telecine pattern while maintaining a picture state machine. A telecine detection module or unit may inform a telecine correction module or unit of the picture state information. The state information indicates the type of fetching action to be performed for telecine correction. Different Telecine correction actions may be performed for each state as shown in Table 2.

TABLE 2
Actions in Telecine Correction

| | | | | | |
|---|---|---|---|---|---|
| Picture | State_1 | State_2 | State_3 | State_4 | State_5 |
| State | | | | | |
| Action | Unchanged | No | Correction | Unchanged | Unchanged |
| De- | | output | | | |
| scrip- | | | | | |
| tion | | | | | |
| Action | Progressive | No | Correction | Progressive | Progressive |
| | fetch | fetch | fetch | fetch | fetch |

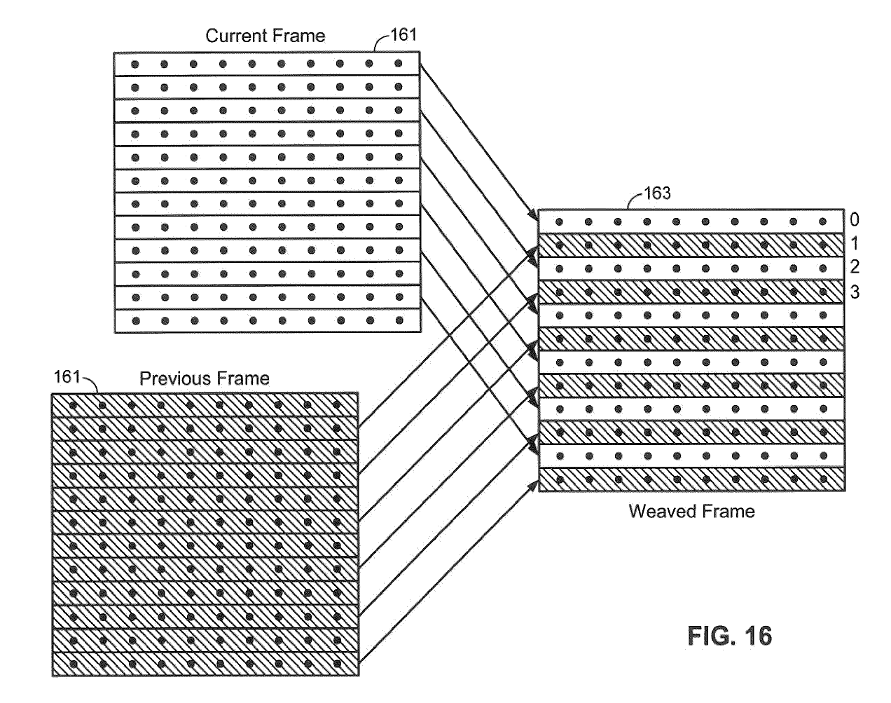

Telecine detection may informs the display (e.g., display device 30 of FIG. 3) of the correct buffer location and correct action (e.g., progressive fetch or correction fetch). If the picture state is State_1, State_4 or State_5, no action is necessary. In other words they are progressive frames and they will be fetched progressively. If the picture is in State_2, then it is discarded. If the picture is in state State_3, it means the picture is in interlaced format and needs to be corrected by swapping the current bottom field of a picture with previous picture's bottom field. This corrective fetch is illustrated in FIG. 16, wherein odd fields of a current frame 161 are combined with even fields of a previous frame 162 to form a weaved frame 163.

A telecine detection module could be implemented within video decoder. This is a convenient location since more than half of the pixels in a frame, which are used by a telecine detection unit may already in an internal memory, and in this case, do not need to be fetched from external memory. This implementation provides advantage in terms of reducing data traffic associated with memory fetches, i.e., reducing the use of memory bandwidth. Once telecine is detected, information such as “Film Mode Flag” and a “Picture State” could be sent to telecine correction module. After telecine correction, the corrected frame may be processed by a pixel processing pipeline, which may include algorithms for image scaling, sharpening and enhancement, and possibly other image processing.

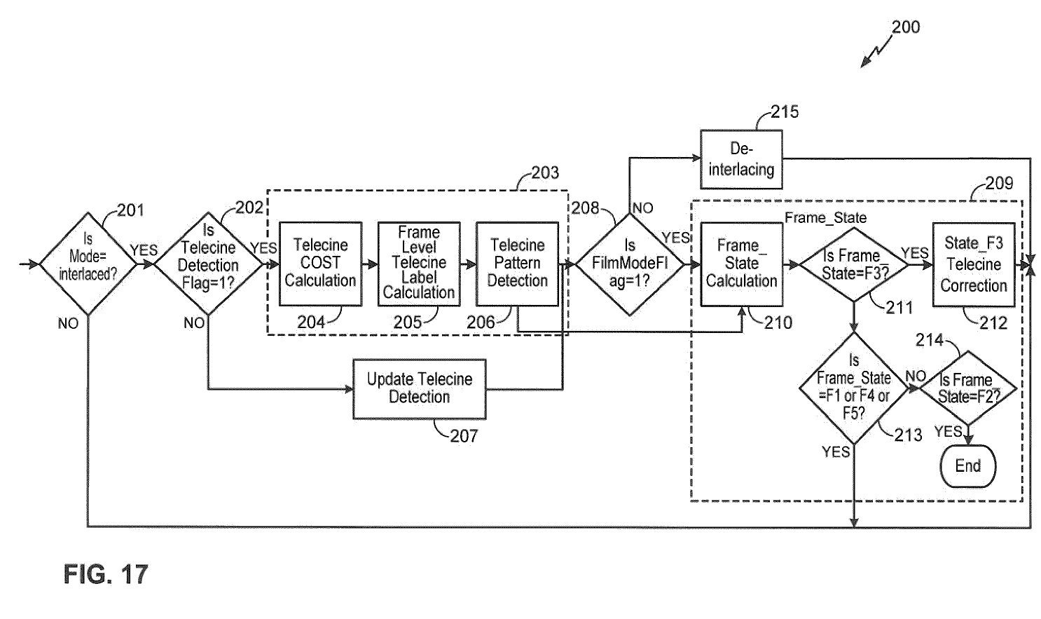

One implementation of the techniques of this disclosure is shown in FIG. 17, which is a combined block diagram and flow diagram of a device 200. Initially, device 200 checks whether the input is interlaced format or not (201). If it is interlaced (“yes” 201) and if a telecine detection flag is ON (“yes” 202), then telecine detection is performed by telecine detection unit 203, which include a telecine cost calculation unit 204, a frame level telecine label calculation unit 205, and a telecine pattern detection unit 206. If the input video is not in interlaced format, the entire inverse telecine process (both detection and correction) is bypassed. If the input is in interlaced format and the telecine detection flag is OFF, then the telecine detection is bypassed, telecine correction is performed based on the state information provided by a state machine. There could be special cases (or bugs) in DVDs where the mode is not set to interlaced even though the content is originally interlaced. For those cases, unit 201 could be bypassed.

At the beginning of decoding, a telecine detection flag may be automatically ON. However, once the pull down pattern is found and locked, the flag can be turned OFF. The telecine detection flag may be controlled by a “telecine update” module labeled as update telecine detection unit 207. This update telecine detection unit 207 enables telecine detection in regular intervals even though a pull down pattern might be locked, and may help the algorithm to identify potential “bad edits.”

When the telecine detection flag is ON (“yes” 202), the first step of the algorithm may be to perform “Cost Calculation.” The output of telecine cost calculation unit 204 is passed to frame level telecine label calculation unit 205, in which the state of each picture is identified. The state information of each picture is used by telecine pattern detection unit 206 (as described herein) to determine whether the video is telecined or not. If a pull down pattern is found, telecine is locked and a “film mode flag” is turned ON. When the Film Mode Flag is ON (“yes” 208), device 200 can calculate the states of each picture. The state information dictates telecine correction unit 209 how to perform the correction since there is different method of correction for each state.

Frame_State Calculation unit 210 may calculate the states of each picture, and output the Frame_State. If the Frame_State is F3, telecine correction unit 209 performs State_F3 telecine correction 212 as described above for State 3. If the Frame_State is state 1, 4 of 5 (“Yes” 213), then those frames are output as being progressive frames. If Frame_State is state 2 (“Yes” 214), the process ends and nothing is output for that frame, i.e., frames in state 2 are dropped in the inverse telecine correction process.

If the Film Mode Flag is OFF, then de-interlacing is applied on the frame by de-interlacing unit 215. Different portions of the algorithm could be partitioned into hardware or software depending on the implementation platform.

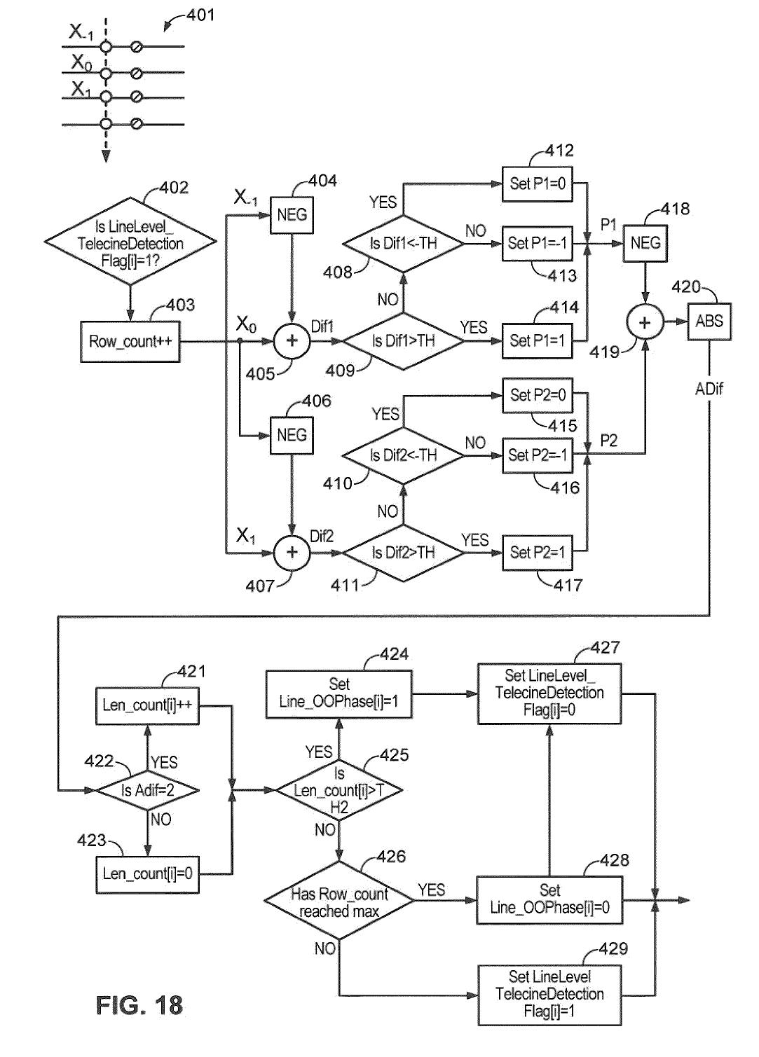

Telecine cost calculation may be performed on a per pixel basis as shown in FIG. 18. For example, this process may scan and process the pixel values in a column-wise manner. X₁, X₀, X₁ in 21 represent consecutive pixels in a column, where X₀ is the current pixel. When LineLevel_telecine detection flag is set to 1 (“yes” 402), Row_co may be incremented (403) and the following steps may be executed:
1. Take difference of X₀ and X₋₁ and set the difference to Dif1 (adder 405 and negative unit 404 may be used for these operations)
2. If Dif1>TH, set P1=1 (409 and 414); If Dif1<−TH, set P1=−1 (408 and 413), else set P1=0 (412).
3. Take difference of X₁ and X₀ and set the difference to Dif2 (adder 407 and negative unit 406 may be used for these operations)
4. If Dif2>TH, set P2=1 (411 and 417); If Dif2<−TH, set P2=−1 (410 416), else set P2=0 (415)
5. Take the absolute value of the difference of P1 and P2, and set it to ADif (adder 419 and negative unit 418 may be used for the difference operations, and ABS unit 420 may perform the absolute value operation).
6. If ADif=2, increase Len count[i] for that column (i.e., i th column) (“yes” 422 and 421); If ADif≠2, set Len_count[i]=0 (“no” 422 and 423)
7. If Len count[i]≧Th2, set Line_OOPhase[i]=1, and set LineLevelTelecineDetectionFlag=0 (“yes” 425, 424 and 427)
8. If Len_count[i]<Th2 and If Row_count reached max (i.e., all the pixels in a column are processed), then set Line_OOPhase[i]=0 (“no” 425, “yes” 426 and 428)
9. If Len count[i]<Th2 but Row_count has not reached max (i.e., all the pixels in a column are NOT processed), then set Line_OOPhase[i]=1 and continue processing the next pixels in a column (“no” 425, “no” 426 and 429)

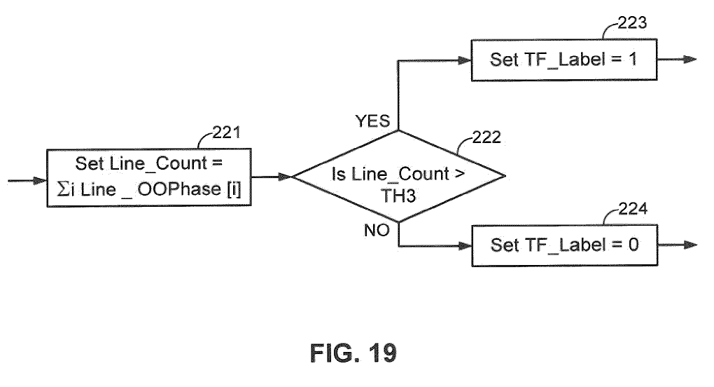

Referring now to FIG. 19, after processing all the pixels, the Line_OOPhase[ . . . ] which specifies whether each column is in phase (i.e., show progressive characteristics) or out of phase (i.e., show interlaced characteristics) can be processed, e.g., via software. Line_Count is set to the summation of the corresponding Line_OOPhase[i] (221). If the number of columns that are out of phase is larger than TH3 (“yes 222), the Picture Label is set to 1 (223) (specifying that it is interlaced), or else it is set to 0 (224) (specifying it is progressive).

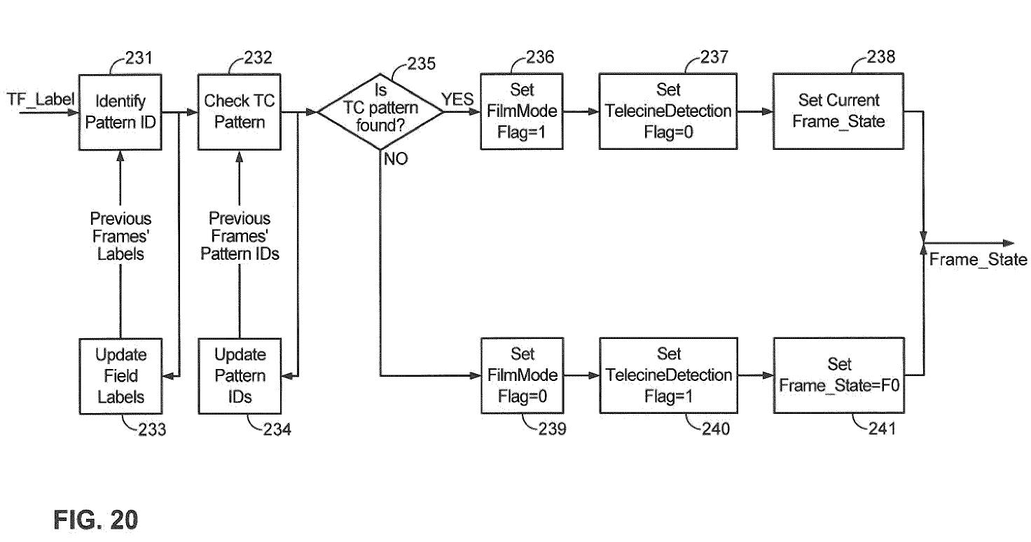

An overview of exemplary algorithms in telecine pattern analysis and detection is presented in FIG. 20. A telecine pattern analysis and detection algorithm may identify a pattern ID (231), update field labels (233), check a telecine (TC) pattern (232), and update pattern IDs (234).

If the telecine pattern is found (“yes” 235), the algorithm sets FilmMode Flag to 1 (236), sets TelecineDatection Flag to 0 (237), and sets a current frame_state (238). If the telecine pattern is not found (“no” 235), the algorithm sets FilmMode Flag to 0 (239), sets TelecineDatection Flag to 1 (240), and sets a current frame_state to F0 (241).

The input to the algorithm shown in FIG. 20 may be viewed as simply “Picture Label” for each picture. The algorithm analyzes the labels of picture within a time window and decides if the video is Telecined or not. The output of the algorithm is “Film Mode Decision” and “Frame State” which are used by a telecine correction module. Individual steps of the algorithm of FIG. 20 may be summarized as follows:
1. Based on the current picture label and previous pictures labels, identify the pattern ID of the current picture.
2. By using the determined current pattern IDs and previous pattern IDs, check whether a telecine pattern exists or not.
3. If telecine pattern is found, set film mode flag to 1 and telecine detection flag to be 0. Determine the state of current picture. (telecine detection flag=0 means that telecine detection [including cost calculation and pattern analysis] will not be performed on the consecutive frames. The correction of consecutive frames will be performed based on state information provided by the state machine).
4. If Telecine pattern is not found, set film mode flag to 0 and telecine detection flag to 1. Also set current state of the picture to be 0. (telecine detection flag=0 means that telecine detection [including cost calculation and pattern analysis] will be performed for the consecutive frames. Setting current state of the picture to be 0 means that no correction will be performed on the current picture. In this case, the telecine correction unit may fetch the frame progressively).

The process of finding pattern IDs for frames may simply involve putting the picture labels of 5 frames in an array, performing template matching over a five pre-determined templates, and finding the Pattern ID of a current picture. In 3:2 pull down, here are five possible pattern options which are given in Table 3 below, with the corresponding states. If the pattern obtained from the input video does not match any one of the five possible pattern options (which is possible if the input is not telecined or the algorithm cannot identify the pattern), then a dummy pattern ID maybe assigned to picture (see FIG. 24).

TABLE 3
Pattern Arrays and their Corresponding IDs and Picture States

| Pattern ID | Pattern Array | Picture State |
|---|---|---|
| 1 | [0 1 1 0 0] | State_5 (F5) |
| 2 | [1 1 0 0 0] | State_1 (F1) |
| 3 | [1 0 0 0 1] | State_2 (F2) |
| 4 | [0 0 0 1 1] | State_3 (F3) |
| 5 | [0 0 1 1 0] | State_4 (F4) |

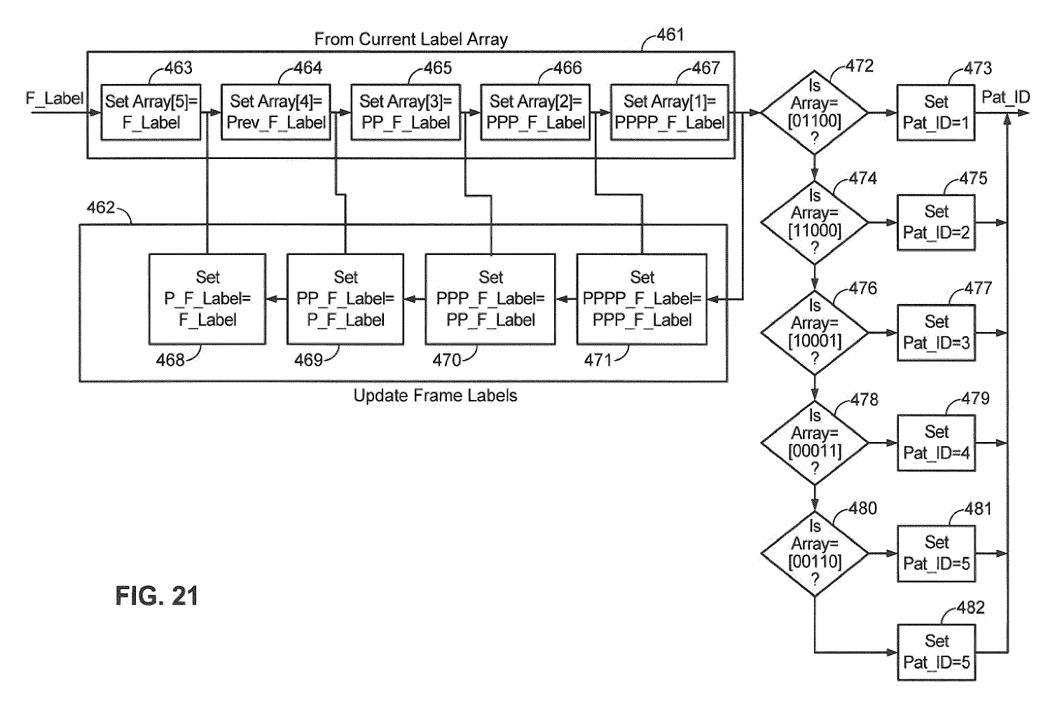

As shown in FIG. 21, an algorithm for defining pattern IDs for frames may include the setting of five different arrays (463, 464, 465, 466 and 467) in a process of forming a current label array (461). Frame labels may be updated 462 as illustrated at steps 468, 469, 470 and 471. Pattern IDs are then set (474, 475, 477, 479 and 481) based on the different arrays listed in 472, 474, 476, 478 and 480. If none of these arrays are identified, a pattern ID of 10 (482) may represent this fact.

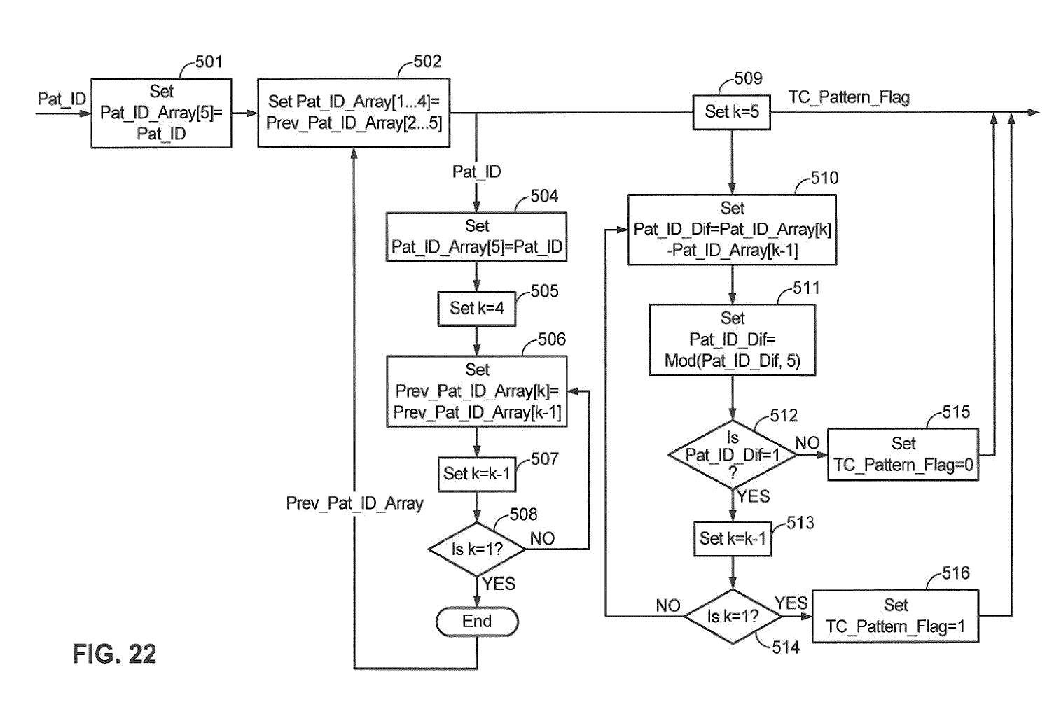

A telecine checking stage may also be executed. Telecine pattern checking is another simple step that determines whether a telecine pattern exists or not. The input to this stage may be the current pattern ID obtained in the manner outlined above. Telecine pattern is detected by using the current Pattern ID as well as the stored pattern IDs from previous frames. The correct 3:2 pull down pattern and the corresponding pattern IDs are given in Table 4, below. A 3:2 Pull down pattern may be found and TC_Pattern_Flag can be set to 1 if the consecutive pattern IDs has a difference of 1 as shown in FIG. 22. Otherwise TC_Pattern_Flag can be set to 0, and Telecine detection algorithm is applied on the consecutive pictures.

TABLE 4

| CPD_32 | 0 | 1 | 1 | 0 | 0 | 0 | 1 | 1 | 0 | 0 | 0 | 1 | 1 | 0 | 0 |
|---|---|---|---|---|---|---|---|---|---|---|---|---|---|---|---|
| Pattern IDs (PID) | | | | | 1 | 2 | 3 | 4 | 5 | 1 | 2 | 3 | 4 | 5 | 1 |
| PID Difference | | | | | | 1 | 1 | 1 | 1 | −4 | 1 | 1 | 1 | 1 | −4 |
| Mod₅ (PID-Dif) | | | | | | 1 | 1 | 1 | 1 | 1 | 1 | 1 | 1 | 1 | 1 |
| CPD_32 | 0 | 1 | 1 | 0 | 0 | 0 | 1 | 1 | 0 | 0 | 0 | 1 | 1 | 0 | 0 |
| Pattern IDs (PID) | 2 | 3 | 4 | 5 | 1 | 2 | 3 | 4 | 5 | 1 | 2 | 3 | 4 | 5 | 1 |
| PID Difference | 1 | 1 | 1 | 1 | −4 | 1 | 1 | 1 | 1 | −4 | 1 | 1 | 1 | 1 | −4 |
| Mod₅ (PID-Dif) | 1 | 1 | 1 | 1 | 1 | 1 | 1 | 1 | 1 | 1 | 1 | 1 | 1 | 1 | 1 |

FIG. 22 illustrates a telecine Pattern Check process that may be implemented by a telecine pattern check state of an inverse telecine process. Various parameters may be set at steps 501, 502, 504, 505, 506 and 507, and values may be adjusted in steps 507 and 508 until a value of k is reduced to 1, where k is an index of the Pattern ID array. Values can then be set in steps 509, 510, 511, and adjusted if Pat_ID_Diff is equal to 1 (“yes” 512), and k is not reduced yet to 1 (513 and “no” 514). If k is one, at this point, the telecine pattern flag is set to 1 (516). If Pat_ID_Diff is not equal to 1 (“no” 512) the telecine pattern flag is set to 1 (515).

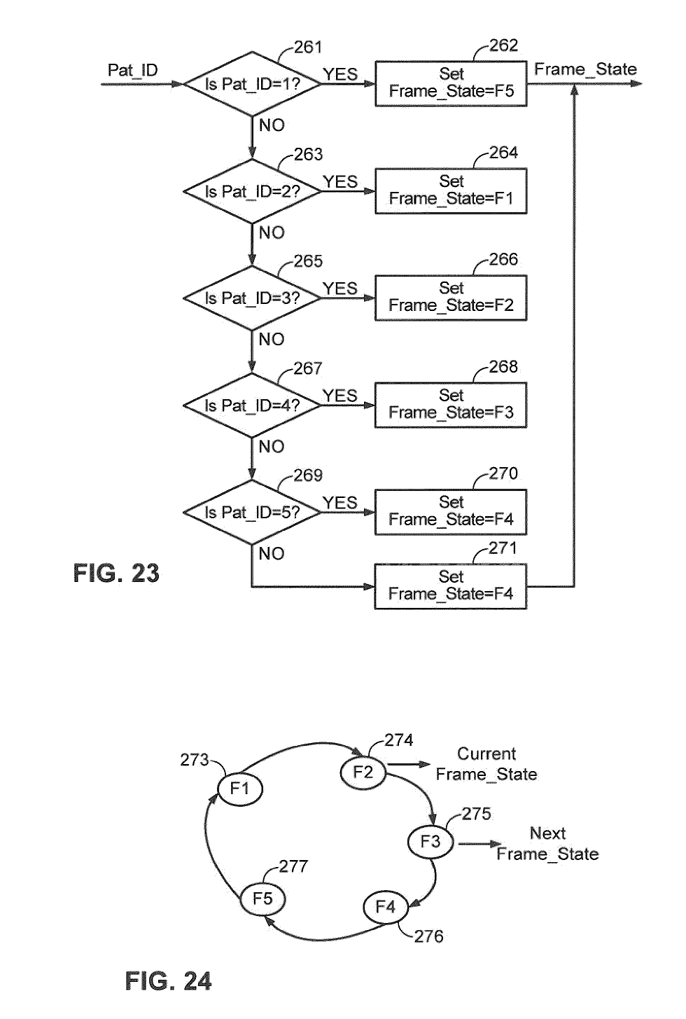

Once the Pattern ID is found, determining the picture state is a simple table look up procedure as shown in FIG. 23 and Table 3, above. In this example, if the pattern ID is 1 (“yes” 261), the frame state is set to 5 (262). If the pattern ID is 2 (“yes” 263), the frame state is set to 1 (264). If the pattern ID is 3 (“yes” 265), the frame state is set to 2 (266). If the pattern ID is 4 (“yes” 267), the frame state is set to 3 (268). If the pattern ID is 5 (“yes” 269), the frame state is set to 4 (270). Otherwise, the frame state is set to 0 (271).

After the telecine detection algorithm identifies a pull down pattern and locks a state, a state machine can maintain the state information of consecutive pictures. For example if the pattern is locked during State_2, the next picture's state becomes State_3, then State_4, then State_5, then state_F1 and back to State_2 FIG. 24 illustrates a states machine that changes from state 2 (274) to state 3 (275) to state 4 (276) to state 5 (277) to state 1 (273), and then repeats such changes. In this way, once the state of one frame is found, the subsequent states of subsequent frames should be known assuming that the telecine process does not change (i.e., assuming that there are no “bad edits”).

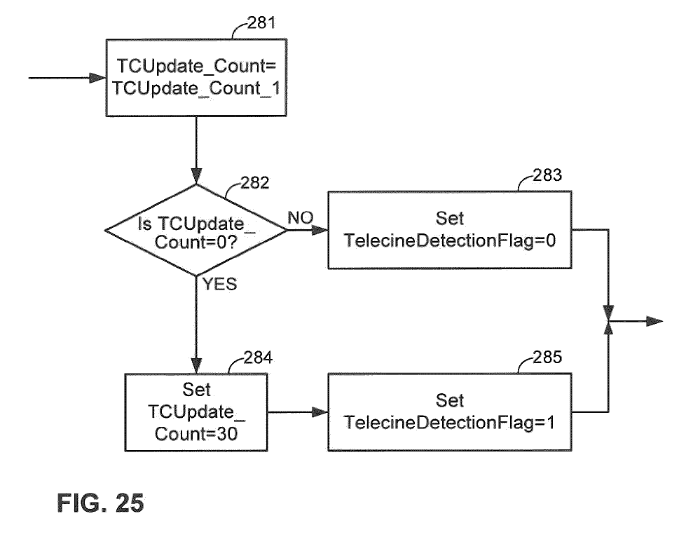

A telecine flag update process is shown in FIG. 25. A count is decremented (281), and if the count is non-zero (“no” 282), the telecine detection flag may be set to zero (283). If the count is zero (“yes” 282), the count may be reset to 30 (284) and the telecine detection flag may be set to one (285).

At the beginning of decoding, a telecine detection flag will be automatically ON. Once the pull down pattern is found and locked, the flag can be turned OFF, telecine detection flag may be controlled by “telecine update” module. Such a “telecine update” module enables telecine detection in regular intervals even though a pull down pattern might be already locked. The update “interval” may be set to 1 second, e.g., 30 frames. Once the pattern is locked, the process may wait for a second (controlled by TC Update Count in FIG. 25) to start checking telecine again and sets the telecine detection flag ON. The time interval may be changed, if desired. Longer waiting period such as 1 minute (1800 frames) or 10 minutes (18000 frames) are also possible. This helps the algorithm to identify potential “bad edits.” If the waiting period is too long, it is possible to miss a bad edit location. If the waiting period is too short and there is no pull down pattern change in the video, then unnecessary power consumption will occur.

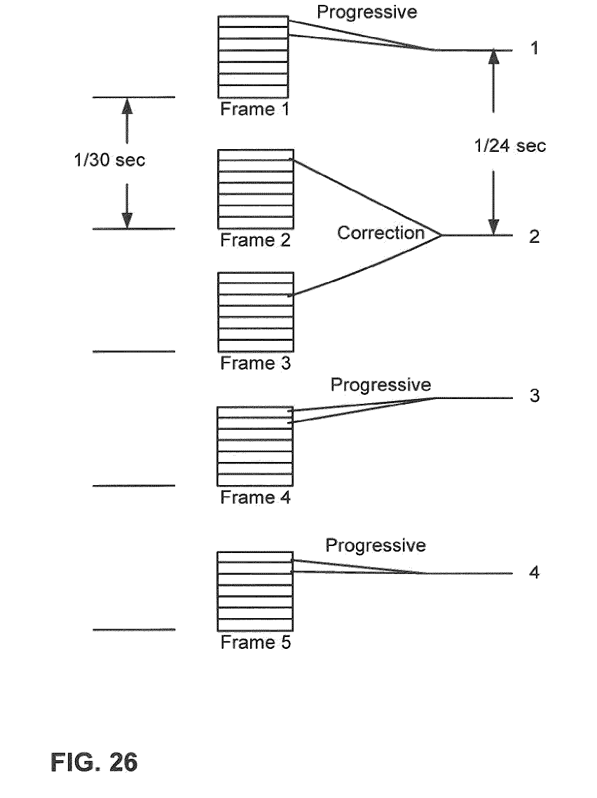

Telecine correction may be performed when frames are fetched for display, in the manner illustrated in FIG. 26. The telecine pattern may be maintained by a state machine, as outlined above. After telecine detection and state determination, a video unit informs the display of the correct buffer location and behavior (progressive fetch or correction fetch). Again, State_1, State_3 and state_5 may be considered as progressive states in 3:2 pull down. If the picture state is State_1, State_3 or State_5, no action is necessary. In other words, frames in states 1, 3 or 5 may be progressive frames that will be fetched progressively in a display processor. If the picture is in State_2, then it is discarded and not fetched or displayed. In other words, the video unit does not pass the frame to the display, and therefore a display processor will not fetch it from the video buffer. This happens for 1 frame out of every 5 frames in 3:2 pull down. If the picture is in State_3, it means the picture is in interlaced format and needs to be corrected by swapping the current bottom field of the picture with the bottom field of the previous picture in the video sequence. This is denoted as “Correction” in FIG. 26. After that video unit adjusts the timing interval from 1/30 seconds to 1/24 seconds, the video unit may mark this content as 24 P by performing a high definition multimedia interface (HDMI) handshaking technique consistent with the HDMI specification.

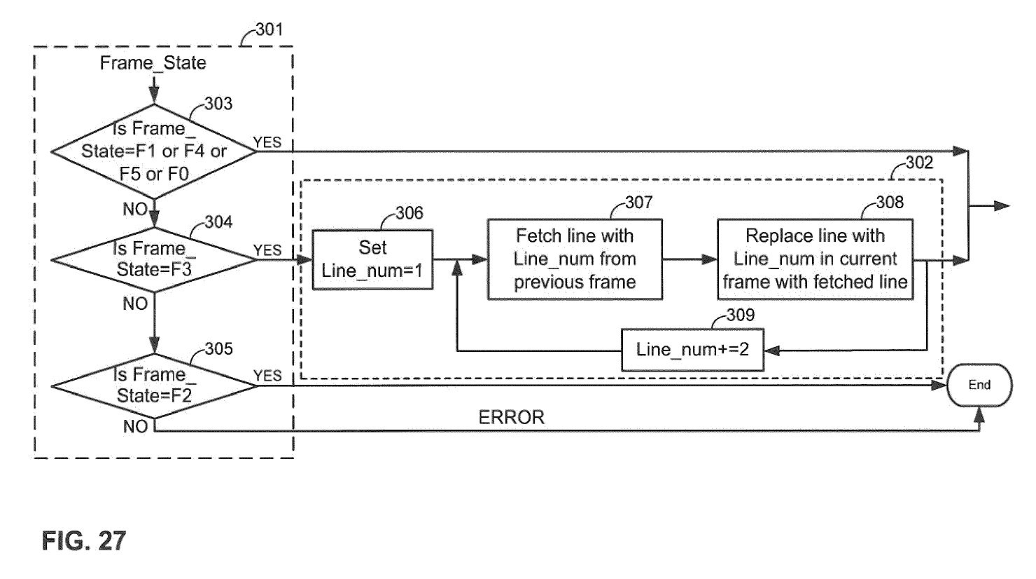

FIG. 27 is a flow diagram illustrating an overview of telecine correction, and further showing one possibility of implementation. In this exemplary implementation, the steps 303, 304 and 305 are performed in unit or module 301, while steps 306, 307, 308 and 309 are preformed in unit or module 302. Frames in states 0, 1, 4 and 5 are fetched normally (“yes” 303). Frames in state 2 are dropped (“yes” 305). Frames in state 3 (“yes” 304 are passed to unit or module 302 so that a corrective de-interlacting fetch can be performed consistent with steps 306, 307, 308 and 309.

Line_OOPhase stores the phase information of each column. This information may be passed to identify the phase information of the whole frame. TH1 and TH2 are thresholds used by the cost calculation algorithm and they may be controlled (i.e., adjusted based on the resolution of the video). Frame_Level_Telecine_Detection_Flag controls whether cost calculation is performed or not.

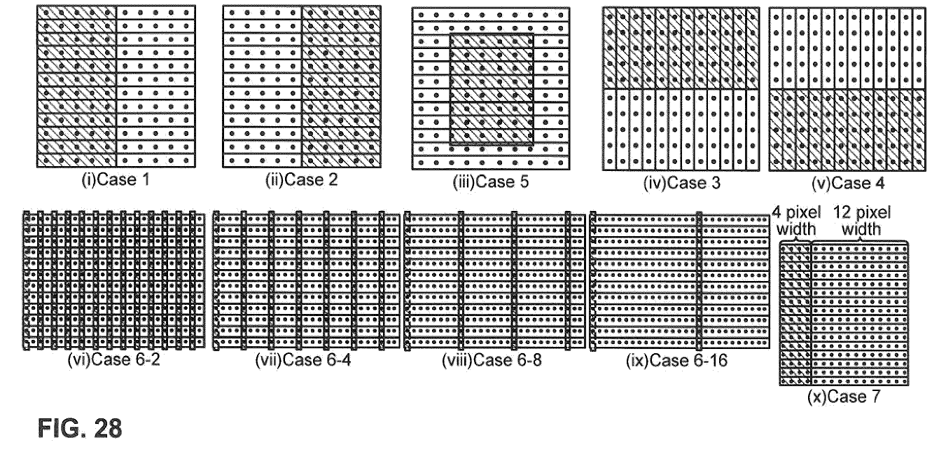

In accordance with another aspect of this disclosure, it may be very desirable to evaluate a portion of a frame when performing telecine detection. By reducing the number of pixels fetched, reductions in memory bandwidth and memory usage may be achieved. There are several options for partial fetches of frames for purposes of telecine detection, some of which are illustrated in FIG. 28, with the fetched portion of the frame shown with shading in FIG. 28.
Option 0: Entire Frame
Option 1: Left Half of a Frame (case 1 of FIG. 28)
Option 2: Right Half of a Frame (case 2 of FIG. 28)
Option 3: Top Half (case 3 of FIG. 28)
Option 4: Bottom Half (case 4 of FIG. 28)
Option 5: Center (case 5 of FIG. 28)
Vertical Sampling A
   Option 6-2: sampling factor=2 (case 6-2 of FIG. 28)
   Option 6-4: sampling factor=4 (case 6-4 of FIG. 28)
   Option 6-8: sampling factor=8 (case 6-8 of FIG. 28)
   Option 6-16: sampling factor=16 (case 6-16 of FIG. 28)
Vertical Sampling B
   Option 7: 4 out of 16 columns are checked for Telecine detection (case 7 of FIG. 28)

The different options for partial fetches of data for purposes of telecine detection may be referred to herein as “deterministic” fetches insofar as the type of data fetch is pre-determined prior to execution of the inverse telecine algorithm. In other words, the data to be fetched is decided in a deterministic manner without considering any bitstream statistics. In another mode, however, the data to be fetched may be determined adaptively by the bitstream information.

In a deterministic method, specific portions of frames to be used for Telecine detection are fetched from the external memory. Again, FIG. 28 illustrates several different sampling options, each of which may be defined and used for deterministic fetches of data to avoid the need to fetch all of the data associated with the frames, but provide an adequate sample of a frame for purposes of inverse telecine. The goal is basically to reduce the number of pixels fetched without degrading the performance of telecine detection. The reduction in the number of pixels that are fetched can be done by either in global fashion like in the cases of 1-5 of FIG. 28, or by using vertical sampling as in the cases of 6-2.

Horizontal sampling is not preferred due to the fact that almost all of the telecine detection makes use of vertical correlation and horizontal sampling will loose important information that is necessary for telecine detection. However, horizontal sampling might have use with some formats of video, and this disclosure generally contemplates horizontal sampling notwithstanding the fact that vertical sampling seems to be more suitable for telecine detection. Some cases, including case 7 of FIG. 28 may allow for sampling on a macroblock level, which may be beneficial when the techniques of this disclosure are used in conjunction with a video processor such as H.264 video decoder.

As noted, adaptive fetching may also be desirable, and may leverage memory loads of similar video data used in video decoding in order to facilitate telecine detection based on such data that is already available. In this case, the amount of data fetched for the inverse telecine algorithm may depend on the motion vector and macroblock mode statistics as well as the GOP (Group of Picture) structure of the video.

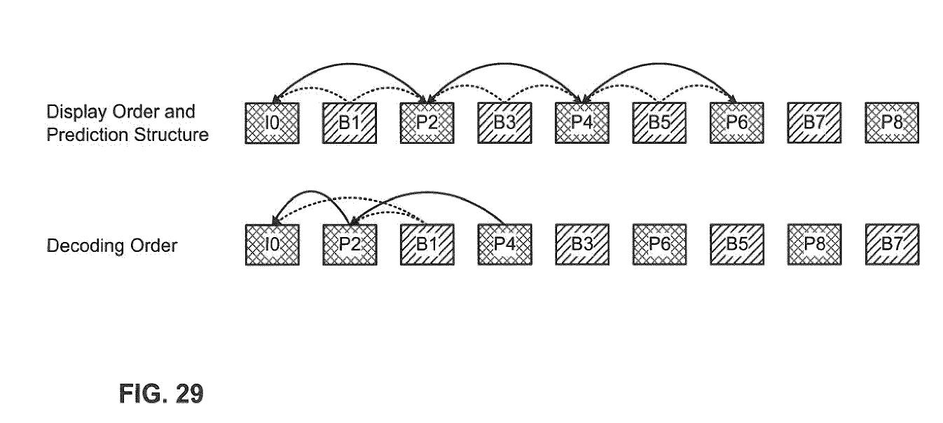

FIG. 29 is a conceptual diagram illustrating the decoding and display order of an “IBP” group of pictures (GOP) structure. In this section, the terms “picture” and “frame” may be used interchanably. An IBP GOP structure includes B pictures, P pictures and I pictures. B pictures and I pictures in interceded based on other pictures. In particular, B pictures are bidirectionally predicted by the previous and next P pictures, whereas P pictures are predicted by using the previous P (or I) pictures. I pictures are intra coded, meaning that they do not depend upon any other pictures, but are coded based on data within that same picture. In inverse telecine, both a current picture (i.e., current even field), and a previous picture (i.e., an odd field) may need to be simultaneously processed to collect enough pixel statistics for Telecine detection. However, due to the differences between display and decoding order (as shown in FIG. 29), care has to be taken to synchronize the inverse telecine data fetch with decoding order.

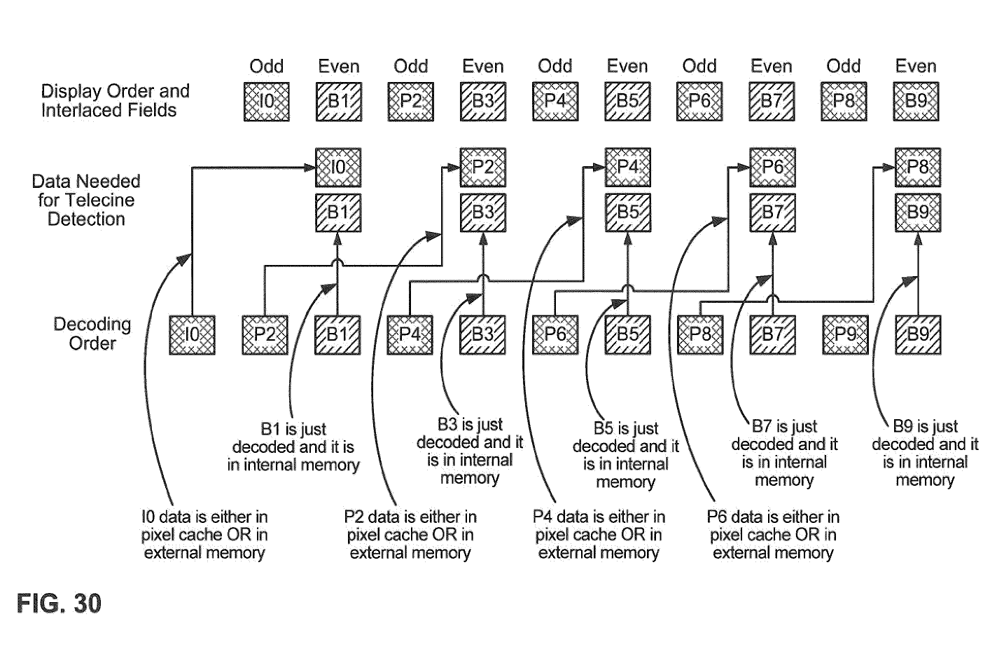

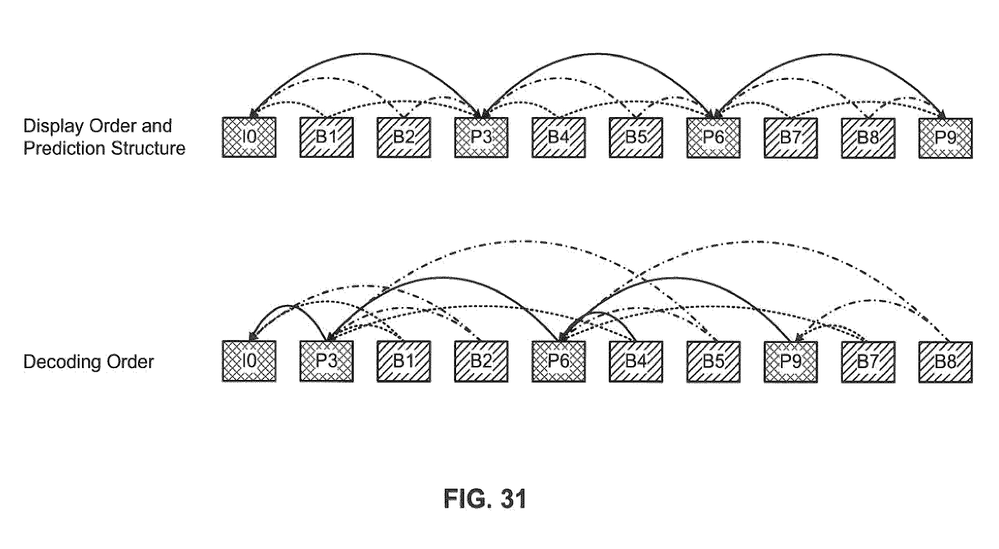

FIG. 30 illustrates exemplary synchronization between inverse telecine data fetch and predictive decoding by a decoder for IBP GOP structure like that illustrated in FIG. 29. For example, when a macroblock from B3 is decoded, the reconstructed macroblock pixels of B3 are may be stored in the internal memory of a processor core, and the processor core may execute both the decoding process and the inverse telecine process. For inverse telecine, P2 which was decoded 3 pictures earlier may need to be fetched from external memory. However, the internal memory (e.g., an internal cache) may be checked to see if the co-located P2 macroblock already exists in the cache. The co-located P2 macroblock (or parts of the macroblock) will typically be in the cache if the current B3 MB macroblock uses it (or parts of it) as a reference for motion compensation. However if the current B3 macroblock does not use P2 as a reference for motion compensation, then the P2 macroblock may need to be fetched from external memory for purposes of inverse telecine. The IBP GOP structure is very compatible with the inverse telecine data fetch. This is due to fact that B pictures typically use the prior P picture for motion compensation. However in IBBP GOP structure, the second B picture (for example B5 in FIG. 31) between P pictures does not use the previous B picture (B4) as reference, therefore this data would typically need to be fetched from external memory in order to execute telecine detection.

FIG. 31 illustrates a typically decoding order of an IBBP GOP structure. The IBP GOP structure is very compatible with the inverse telecine data fetch. This is due to fact that B pictures typically uses the prior P picture for motion compensation. However in IBBP GOP structure, the second B picture (for example B5 in FIG. 31) between P pictures does not use the previous B picture (B4) as reference, therefore this data would typically need to be fetched from external memory in order to execute telecine detection.

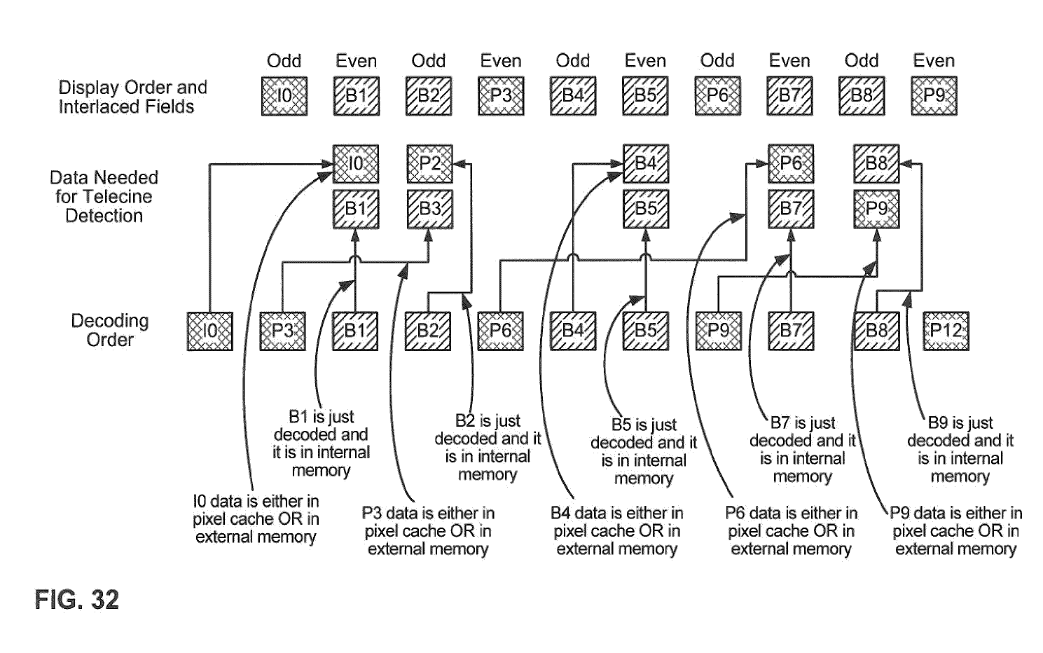

Accordingly, it may require a more intricate process to synchronize data fetches associated with decoding and inverse telecine when an IBBP GOP structure is used. One example of such synchronization is demonstrated in FIG. 32. For this case, the inverse telecine process needs the following field couples to process: I0-B1, B2-P3, B4-B5, P6-B7 and B8-P9. For example, when processing a B2-P3 field couple, the telecine detection algorithm should be be applied during the decoding of B2, since P3 is decoded earlier. The next inverse telecine data fetch (e.g., the B4-B5 field couple) may be performed after decoding B5. Comparing IBP and IBBP structures, it can be seen that data fetches for IBBP are not as regular as for the IBP structure. In IBP GOP, the inverse telecine data is fetched every other field, however in IBBP GOP, inverse telecine data is fetched sometimes consecutively (for example during decoding of B1 and then during decoding of B2), and sometimes every third field (during decoding of B5). Although these fetches may not affect the inverse telecine algorithm performance, the fetches might cause bandwidth jitter during decoding, if the inverse telecine data fetch is not performed in regular intervals.

This disclosure proposes adaptive fetching techniques in order to leverage data fetches for predictive coding and thereby avoid duplicative data fetches for purposes of inverse telecine. The proposed adaptive fetch algorithm may analyzes the bit-stream information to reduce the bandwidth used for pixel fetch. At least two different methods for adaptive fetching are discussed. In the first method, access to bitstream statistics for the whole frame may be presumed. In this case, decisions can be made to identify which pixels to fetch based on global statistics. In the second access to partial statistics (not the whole frame) may be assumed, and in this case, decisions can be made regarding the pixels to fetch based on such available information.

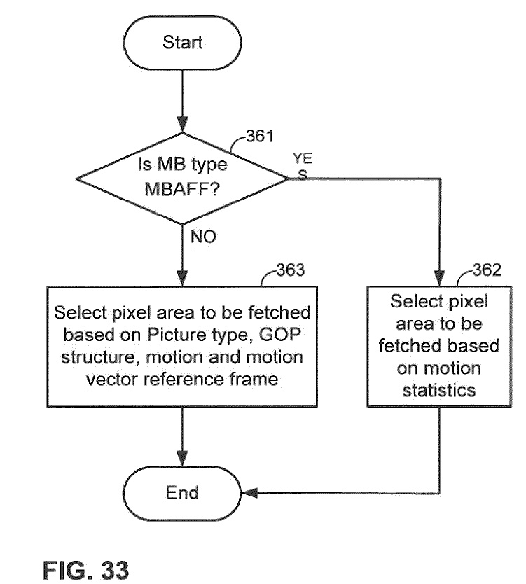

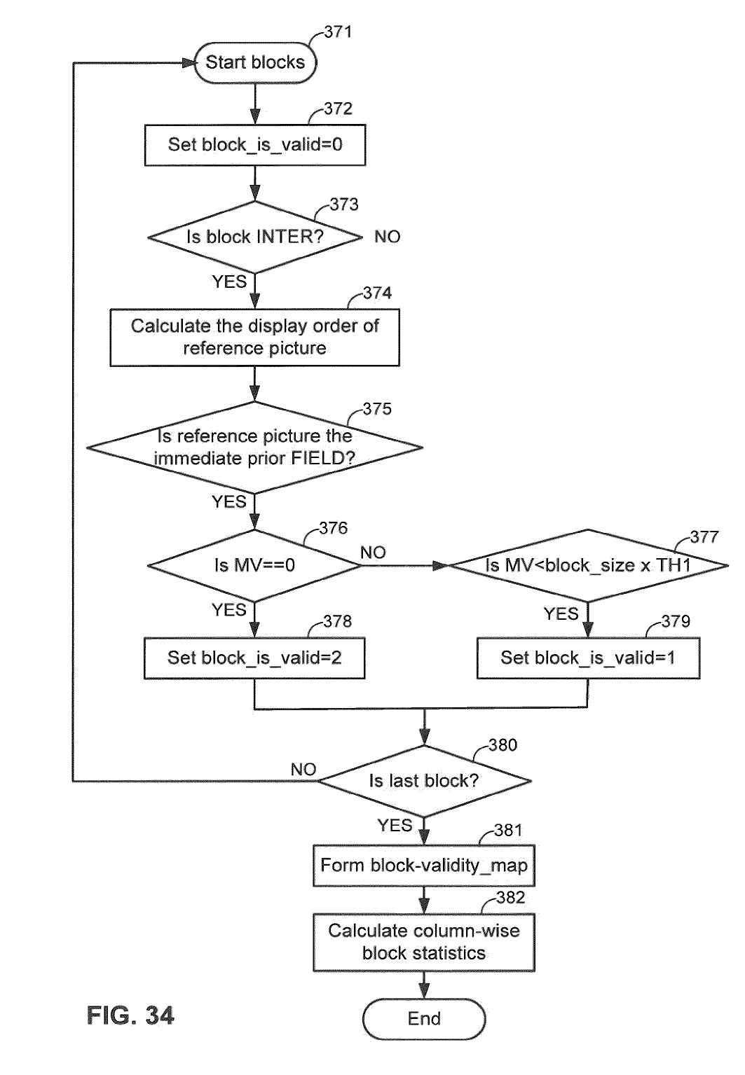

In some cases, there may be complete access to whole frame statistics. In this case, the inverse telecine unit may check whether the macroblocks are encoded in MBAFF format (wherein MBAFF stands for macroblock adaptive frame/field). If the macroblocks are encoded in MBAFF format, then both the current and previous field (i.e., even and odd field of a frame) may already be stored in memory for purposes of predictive video decoding. In this case, the inverse telecine unit does not need to fetch the pixel data associated with a previous field. However, if the macroblocks are not encoded in MBAFF format, then the inverse telecine unit may need to fetch such data, e.g., as illustrated in FIGS. 33 and 34.

As shown in FIG. 33, an inverse telecine unit 29 may determine whether a macroblock (MB) is in MBAFF format (361). If so (“yes” 361), inverse telecine unit 29 may select a pixel area to be fetched based on motion statistics (362). If not (“no” 361), inverse telecine unit 29 may select a pixel area to be fetched based on picture type, GOP structure, motion and the motion vector reference frame used of the macroblock.

As shown in FIG. 34, an inverse telecine unit 29 may start the processing of blocks (371) by setting a block_is_valid bit to zero (372). Inverse telecine unit 29 may determine whether the block is inter-coded (373). Inverse telecine of intra coded blocks may not benefit from aspects of this disclosure that reuse data from predictive coding for inverse telecine insofar as intra coded blocks are coded based on data within the same block and not data from other blocks. If the block is inter coded (“yes” 373), inverse telecine unit 29 may calculate the display order of the reference picture (374), and determine whether the reference picture is the immediate prior field (375).

If the reference picture is the immediate prior field (“yes” 375), inverse telecine unit 29 may determine whether the motion vector is zero (376). If so (“yes” 376), inverse telecine unit 29 may set the block_is_valid bit to 2. If the reference picture is the immediate prior field (“yes” 375), the motion vector is not zero (“no” 376) and the motion vector is less than block_size multiplied by a threshold (TH1), then inverse telecine unit 29 may set the block_is_valid bit to 1. This process may be repeated for every block of a frame (or every block of a subset of a frame) until the last block is reached (380). After reaching the last block (“yes” 380), inverse telecine unit 29 may form a block_validity_map (381) and calculate column-wise block statistics (382) based on the block_validity_map. The block_validity_map may basically identify blocks as having bits 0, 1 or 2. Bit 2 means that the data for that macroblock is already stored in memory, bit 1 means that some of the data for that macroblock may be stored in memory, and bit 0 means that none of the data for that macroblock is stored in memory. Thus, by forming the block_validity_map, useful columns of data (e.g., columns with predominately block_valid_bits equal to 2) may be used for purposes of inverse telecine. Such columns may correspond to data that is already stored in memory, and therefore, memory fetches of such data can be avoided.

Put another way, inverse telecine unit 29 may process all the blocks, and analyze block statistics to form a “block_validity” map. For each block, a value between 0 and 2 is assigned. A larger value implies a better block which helps to reduce bandwidth, i.e., the whole block or large portions of the block from previous field can be found in the internal memory. For each block, first the block mode is checked. If it is inter mode and motion is referencing to immediately previous frame and furthermore if the motion vector is zero, inverse telecine unit 29 may set the block label to be 2.

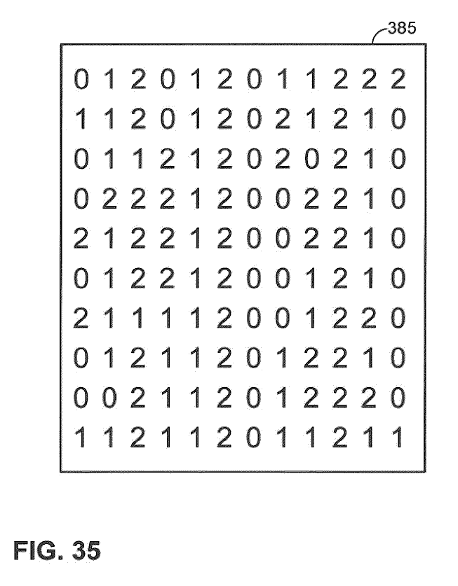

The reason that inverse telecine unit 29 may look for a zero motion vector is that for telecine detection the collocated block from previous field is needed. If the motion vector is not zero, but less than some threshold value, inverse telecine unit 29 may set the block label to 1. Block value 1 means that portions of the collocated block that will be used for telecine detection are in the internal memory and only part of it has to be fetched from outside. Block value 0 means that collocated block in the previous field is not available and, has to be completely fetched. After processing all the blocks, inverse telecine unit 29 may form block_validity_map. An example of the map is shown in FIG. 35.

In particular, FIG. 35 shows an example block validity map 385 comprising a set of valid bits set to values of 0, 1 or 2. The value of 2 means that all of the data for a corresponding video block is already stored in internal memory, the value of 1 means that some of the data for the corresponding video block is already stored in internal memory, and the value of 0 means that none of the corresponding video block is already stored in internal memory. As can be seen from block validity map 385, the sixth and tenth rows have all “2s,” which means that each video block in these rows will have the corresponding video block is already stored in internal memory. An inverse telecine unit may prefer use of these rows in performing telecine detection because data fetches may be avoided for these rows insofar as the data may already be stored in internal memory for purposes of predictive coding.

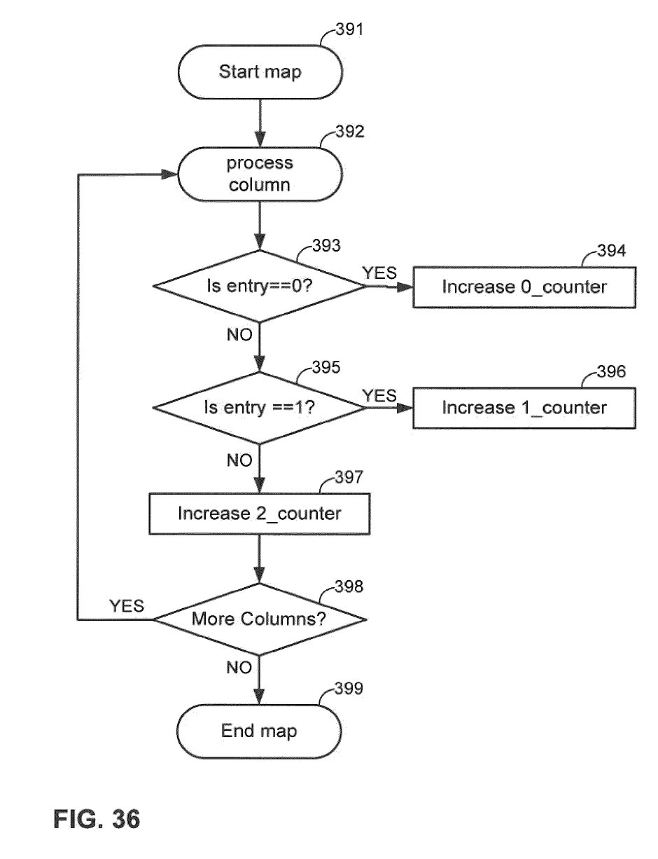

FIG. 36 is a flow diagram illustrating a process analyzing a validity map such as block validity map 385 of FIG. 35. As shown, upon starting a map (391), inverse telecine unit 29 processes a column (392). For each column, inverse telecine unit 29 counts the number of video blocks that are assigned values of 0, 1 and 2. If an entry is 0 (“yes” 393) a 0_counter is incremented (394). If an entry is 1 (“yes” 395) a 1_counter is incremented (396). If an entry is 2 (“no” 395) a 2_counter is incremented (397). The process can be repeated for every column (“yes” 394) until all of the columns have been considered (“yes” 394), at which point consideration of the map is finished (399).

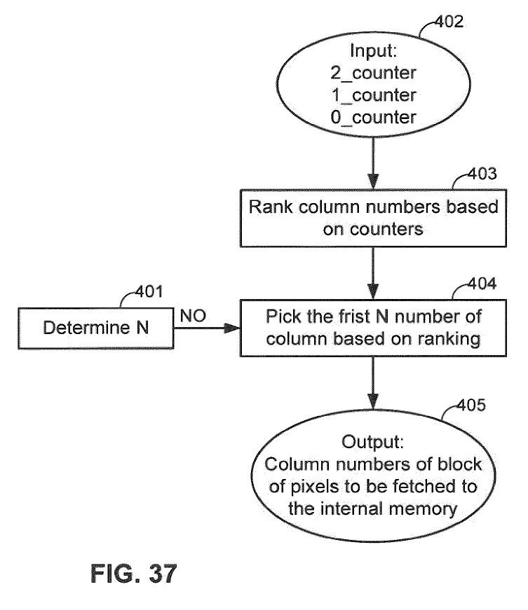

FIG. 37 is a flow diagram illustrating the analysis of a validity map. In this case, a map unit (not shown) within inverse telecine unit 29 receives the input associated with the 0_counter, the 1_counter and the 2_counter. The map unit ranks columns based on the counters. Higher values for the 2_counter result in higher ranks, while higher values for the 0_counter result in lower ranks. Inverse telecine unit 29 may determine N (401), wherein in this case, N corresponds to a number of columns to be used for inverse telecine. Based on the rankings, the map unit can then pick the N columns from the validity map to be used for inverse telecine. The map unit can then output the pixels associated with most desirable column numbers, and deliver such data to internal memory and used by inverse telecine unit 29 (405). To the extent that data is already stored in the internal memory (e.g., blocks that are assigned values of 2 or portions of blocks that are assigned values of 1), such data does not need to be re-fetched.

Thus, according to the techniques of FIGS. 36 and 37, columnwise statistics of the block_validity map can be collected. For each column, an inverse telecine unit may count the individual block labels. An example of label counters corresponding to the map of FIG. 35 is shown below in Table 8

TABLE 5

| Column-1 | Column-2 | | Column-10 | Column-11 | Column-12 |
|---|---|---|---|---|---|
| 0_counter = 6 | 0_counter = 1 | . . . | 0_counter = 0 | 0_counter = 0 | 0_counter = 8 |
| 1_counter = 2 | 1_counter = 8 | | 1_counter = 0 | 1_counter = 7 | 1_counter = 1 |
| 2_counter = 2 | 2_counter = 1 | | 2_counter = 10 | 2_counter = 3 | 2_counter = 1 |

The columns can be ranked based on the labels and N number of the columns can be selected to be fetched from the external memory. The number N can either be a predetermined value, or can be adjustable. When a given block is in MBAFF format, both fields can be found in the internal memory after decoding. However in this case, a decision still needs to be given based on motion statistics in order to reduce the amount of processing that is performed for telecine detection. This case may not necessarily reduce the bandwidth but may still reduce the amount of memory used by hardware for analyzing a frame. The memory reduction may also be achieved by reducing the portions of a frame to be analyzed.

In order to decide which portions of a frame to use in telecine detection, the inverse telecine unit may apply a simple algorithm which uses motion statistics and prediction error. A similar block_validity motion map can be formed, in which a label of 2 is assigned to blocks with high motion and prediction error, a label of 1 is assigned to smaller motion blocks and 0 label is assigned to intra blocks. A similar ranking-based method can then be applied to select the appropriate block of pixels to fetch from the external memory.

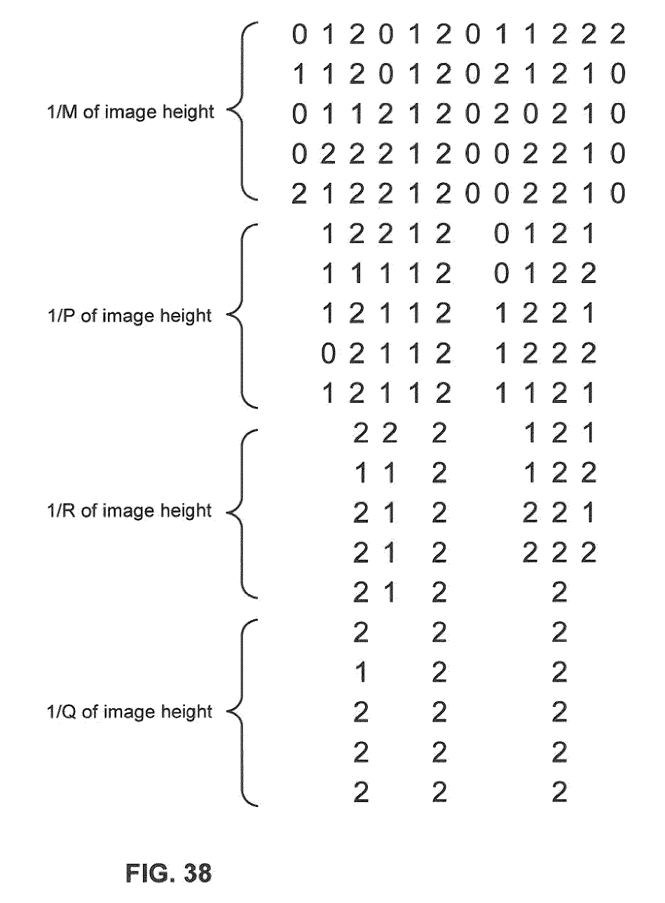

FIG. 38 is a conceptual diagram illustrating another form of validity map, which is a partial map. In this case, however, columns may be eliminated in stages as being bad candidate columns for purposes of telecine detection. As shown, all of the columns may be considered up to 1/M of the image height, where M is an integer. At this point, columns that predominantly have blocks that are assigned values of 0 or 1, and not 2, may be discarded. Thus, after 1/M of the image height, the first, seventh and twelfth columns are not processed since they are bad candidates. A first subset of the columns may be processed through 1/P of the image height, where P is an integer smaller than M. At this point, more columns may be eliminated. A second subset of the columns may be processed through 1/R of the image height, where R is an integer smaller than P. At this point, more columns may be eliminated. A third subset of the columns may be processed through 1/Q of the image height, where Q is an integer smaller than R.

The processing technique conceptually illustrated in FIG. 38 may reduce the amount of processing needed to identify the desirable columns to be used for inverse telecine detection. Again, the desirable columns are those that have the most blocks assigned values of 2, as these blocks do not require memory fetches insofar as the data may have already been fetched for purposes of predictive coding. As shown, the third, sixth and tenth columns appear to be well suited for memory efficient inverse telecine detection.

The example of FIG. 38 may utilize only partial statistics of a frame, e.g., as such statistics become available in the video coding. In this case, the inverse telecine unit may have access to only partial frame statistics, and a pixel fetch decision may be determined while the decoding of a block is occurring. For this case, the inverse telecine unit may collect statistics as blocks are decoded by a decoding. As illustrated in FIG. 38, initially, all the collocated blocks are fetched from the previous field for a certain number of rows since it is unknown which columns of pixels will be used for inverse telecine. The number of rows may be fixed to correspond to only 1/Mth of image height. While decoding, block labels can be calculated and column-wise statistics are collected. In the next portion of the image (1/Pth of image width), only columns which have higher block label values (determined in stage 1) are fetched from the external memory. Then, the next stage fetches only those column blocks whose labels are higher. In each stage the number of blocks to be fetched can be reduced.

In summary, the proposed techniques may be beneficial in facilitating inverse telecine detection, and in reducing the bandwidth and memory requirements of video decoders/processors for the telecine detection process. The bandwidth reduction is basically performed by identifying the pixel areas of the previous field which are already in the memory, and selecting those columns of pixels to perform telecine detection either deterministically or adaptively by using bitstream characteristics.

The techniques of this disclosure may be embodied in a wide variety of devices or apparatuses, including a wireless handset, and integrated circuit (IC) or a set of ICs (i.e., a chip set). Any components, modules or units have been described provided to emphasize functional aspects and does not necessarily require realization by different hardware units, etc.

Accordingly, the techniques described herein may be implemented in hardware, software, firmware, or any combination thereof. Any features described as modules or components may be implemented together in an integrated logic device or separately as discrete but interoperable logic devices. If implemented in software, the techniques may be realized at least in part by a computer-readable medium comprising instructions that, when executed, performs one or more of the methods described above. The computer-readable data storage medium may form part of a computer program product, which may include packaging materials. The computer-readable medium may comprise random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates code in the form of instructions or data structures and that can be accessed, read, and/or executed by a computer.

The code may be executed by one or more processors, such as one or more digital signal processors (DSPs), general purpose microprocessors, an application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated software modules or hardware modules configured for encoding and decoding, or incorporated in a combined video codec. Also, the techniques could be fully implemented in one or more circuits or logic elements.

Various aspects of the disclosure have been described. These and other aspects are within the scope of the following claims.

1. A method comprising:
determining whether individual video frames in a sequence of video frames are progressive frames or interlaced frames;
identifying a pattern of the progressive frames and the interlaced frames in the sequence of video frames;
identifying a telecine technique based on the pattern; and
performing an inverse telecine technique with respect to the sequence of video frames based on the identified telecine technique, wherein the inverse telecine technique converts N video frames per second to M video frames per second wherein M and N are positive integers and M is less than N.

2. The method of claim 1, wherein the pattern is associated with a 3:2 pull down telecine technique, and wherein identifying the pattern comprises identifying five frame sequences that consist of three progressive frames and two interlaced frames in a specific order associated with the 3:2 pull down.

3. The method of claim 2, wherein performing the inverse telecine technique comprises converting the five frame sequences to four frame sequences, wherein the inverse telecine technique converts 30 video frames per second to 24 video frames per second.

4. The method of claim 1, wherein identifying whether individual video frames in the sequence of video frames are progressive frames or interlaced frames comprises processing only a subset of data associated with the individual video frames.

5. The method of claim 4, wherein the subset comprises a block of pixel data within the individual frames, wherein the block is pre-defined for inverse telecine detection, and wherein the block of pixel data is fetched from memory for each of the individual frames.

6. The method of claim 4, wherein the subset comprises vertical columns of pixel data within the individual frames, wherein the vertical columns of pixel data within the individual frames are pre-defined for inverse telecine detection, and wherein the vertical columns of pixel data within the individual frames are fetched from memory for each of the individual frames.

7. The method of claim 4, wherein the subset comprises vertical columns of pixel data within the individual frames, wherein the vertical columns of pixel data within the individual frames are adaptively defined based on whether data has already been fetched from memory for use in predictive video coding.

8. The method of claim 4, wherein the subset associated with any given frame is adaptively defined based on whether data has already been fetched from memory for use in predictive video coding.

9. The method of claim 8, further comprising:
generating a map of pixels associated with a respective frame to define whether data has already been fetched from memory for use in predictive video coding; and defining the subset for the respective frame based on the map.

10. The method of claim 8, further comprising:
generating a partial map of pixels associated with a respective frame to define whether data has already been fetched from memory for use in predictive video coding; and defining the subset for the respective frame based on the partial map, wherein the partial map is defined during the predictive video coding of the respective frame as statistics become available, wherein the statistics define whether individual pixels have already been fetched for the predictive video coding.

11. A video processing apparatus comprising an inverse telecine unit that:
determines whether individual video frames in a sequence of video frames are progressive frames or interlaced frames;
identifies a pattern of the progressive frames and the interlaced frames in the sequence of video frames;
identifies a telecine technique based on the pattern; and
performs an inverse telecine technique with respect to the sequence of video frames based on the identified telecine technique, wherein the inverse telecine technique converts N video frames per second to M video frames per second, wherein M and N are positive integers and M is less than N.

12. The apparatus of claim 11, wherein the pattern is associated with a 3:2 pull down telecine technique, and wherein the inverse telecine unit identifies five frame sequences that consist of three progressive frames and two interlaced frames in a specific order associated with the 3:2 pull down.

13. The apparatus of claim 12, the inverse telecine unit performs the inverse telecine technique to converting the five frame sequences to four frame sequences, wherein the inverse telecine technique converts 30 video frames per second to 24 video frames per second.

14. The apparatus of claim 11, wherein in identifying whether individual video frames in the sequence of video frames are progressive frames or interlaced frames, the inverse telecine unit processes only a subset of data associated with the individual video frames.

15. The apparatus of claim 4, wherein the subset comprises a block of pixel data within the individual frames, wherein the block is pre-defined for inverse telecine detection, and wherein the block of pixel data is fetched from memory for each of the individual frames.

16. The apparatus of claim 4, wherein the subset comprises vertical columns of pixel data within the individual frames, wherein the vertical columns of pixel data within the individual frames are pre-defined for inverse telecine detection, and wherein the vertical columns of pixel data within the individual frames are fetched from memory for each of the individual frames.

17. The apparatus of claim 14, wherein the apparatus further comprises a video decoder that performs predictive video coding, wherein the subset comprises vertical columns of pixel data within the individual frames, wherein the vertical columns of pixel data within the individual frames are adaptively defined based on whether data has already been fetched from memory for use in the predictive video coding.

18. The apparatus of claim 14, wherein the apparatus further comprises a video decoder that performs predictive video coding, wherein the subset associated with any given frame is adaptively defined based on whether data has already been fetched from memory for use in the predictive video coding.

19. The apparatus of claim 18, wherein the apparatus further comprises a video decoder that performs predictive video coding, wherein the inverse telecine unit:
generates a map of pixels associated with a respective frame to define whether data has already been fetched from memory for use in the predictive video coding; and defines the subset for the respective frame based on the map.

20. The apparatus of claim 18, wherein the apparatus further comprises a video decoder that performs predictive video coding, wherein the inverse telecine unit:
generates a partial map of pixels associated with a respective frame to define whether data has already been fetched from memory for use in predictive video coding; and defines the subset for the respective frame based on the partial map, wherein the partial map is defined during the predictive video coding of the respective frame as statistics become available, wherein the statistics define whether individual pixels have already been fetched for the predictive video coding.

21. The apparatus of claim 11, wherein the apparatus comprises an integrated circuit.

22. The apparatus of claim 11, wherein the apparatus comprises a microprocessor.

23. The apparatus of claim 11, wherein the apparatus comprises a wireless communication device that includes the inverse telecine unit.

24. A device comprising:
means for determining whether individual video frames in a sequence of video frames are progressive frames or interlaced frames;
means for identifying a pattern of the progressive frames and the interlaced frames in the sequence of video frames;
means for identifying a telecine technique based on the pattern; and
means for performing an inverse telecine technique with respect to the sequence of video frames based on the identified telecine technique, wherein the inverse telecine technique converts N video frames per second to M video frames per second, wherein M and N are positive integers and M is less than N.

25. The device of claim 24, wherein the pattern is associated with a 3:2 pull down telecine technique, and wherein means for identifying the pattern comprises means for identifying five frame sequences that consist of three progressive frames and two interlaced frames in a specific order associated with the 3:2 pull down.

26. The device of claim 25, wherein means for performing the inverse telecine technique comprises means for converting the five frame sequences to four frame sequences, wherein the inverse telecine technique converts 30 video frames per second to 24 video frames per second.

27. 1the device of claim 24, wherein means for identifying whether individual video frames in the sequence of video frames arc progressive frames or interlaced frames comprises means for processing only a subset of data associated with the individual video frames.

28. The device of claim 27, wherein the subset comprises a block of pixel data within the individual frames, wherein the block is pre-defined for inverse telecine detection, and wherein the block of pixel data is fetched from memory for each of the individual frames.

29. The device of claim 27, wherein the subset comprises vertical columns of pixel data within the individual frames, wherein the vertical columns of pixel data within the individual frames are pre-defined for inverse telecine detection, and wherein the vertical columns of pixel data within the individual frames are fetched from memory for each of the individual frames.

30. The device of claim 27, wherein the subset comprises vertical columns of pixel data within the individual frames, wherein the vertical columns of pixel data within the individual frames arc adaptively defined based on whether data has already been fetched from memory for use in predictive video coding.

31. The device of claim 27, wherein the subset associated with any given frame is adaptively defined based on whether data has already been fetched from memory for use in predictive video coding.

32. The device of claim 31, further comprising:
means for generating a map of pixels associated with a respective frame to define whether data has already been fetched from memory for use in predictive video coding; and means for defining the subset for the respective frame based on the map.

33. The device of claim 31, further comprising:
means for generating a partial map of pixels associated with a respective frame to define whether data has already been fetched from memory for use in predictive video coding; and means for defining the subset for the respective frame based on the partial map, wherein the partial map is defined during the predictive video coding of the respective frame as statistics become available, wherein the statistics define whether individual pixels have already been fetched for the predictive video coding.

34. A computer-readable medium comprising instructions that when executed by a processor cause the processor to:
determine whether individual video frames in a sequence of video frames are progressive frames or interlaced frames;
identify a pattern of the progressive frames and the interlaced frames in the sequence of video frames;
identify a telecine technique based on the pattern; and
perform an inverse telecine technique with respect to the sequence of video frames based on the identified telecine technique, wherein the inverse telecine technique converts N video frames per second to M video frames per second, wherein M and N are positive integers and M is less than N.

35. The computer-readable medium of claim 34, wherein the pattern is associated with a 3:2 pull down telecine technique, and wherein the instructions cause the processor to identify five frame sequences that consist of three progressive frames and two interlaced frames in a specific order associated with the 3:2 pull down.

36. The computer-readable medium of claim 35, wherein the instructions cause the processor to convert the five frame sequences to four frame sequences, wherein the inverse telecine technique converts 30 video frames per second to 24 video frames per second.

37. The computer-readable medium of claim 34, wherein in identifying whether individual video frames in the sequence of video frames are progressive frames or interlaced frames the instructions cause the processor to process only a subset of data associated with the individual video frames.

38. The computer-readable medium of claim 37, wherein the subset comprises a block of pixel data within the individual frames, wherein the block is pre-defined for inverse telecine detection, and wherein the block of pixel data is fetched from memory for each of the individual frames.

39. The computer-readable medium of claim 37, wherein the subset comprises vertical columns of pixel data within the individual frames, wherein the vertical columns of pixel data within the individual frames are pre-defined for inverse telecine detection, and wherein the vertical columns of pixel data within the individual frames are fetched from memory for each of the individual frames.

40. The computer-readable medium of claim 37, wherein the subset comprises vertical columns of pixel data within the individual frames, wherein the vertical columns of pixel data within the individual frames are adaptively defined based on whether data has already been fetched from memory for use in predictive video coding.

41. The computer-readable medium of claim 37, wherein the subset associated with any given frame is adaptively defined based on whether data has already been fetched from memory for use in predictive video coding.

42. The computer-readable medium of claim 41, further comprising instructions that cause the processor to:
generate a map of pixels associated with a respective frame to define whether data has already been fetched from memory for use in predictive video coding; and
define the subset for the respective frame based on the map.

43. The computer-readable medium of claim 41, further comprising instructions that cause the processor to:
generate a partial map of pixels associated with a respective frame to define whether data has already been fetched from memory for use in predictive video coding; and
define the subset for the respective frame based on the partial map, wherein the partial map is defined during the predictive video coding of the respective frame as statistics become available, wherein the statistics define whether individual pixels have already been fetched for the predictive video coding.
